(19) United States
(12) Patent Application Publication
(10) Pub. No.: US 2022/0287013 A1
(43) Pub. Date: Sep. 8, 2022

(54) METHOD AND APPARATUS FOR BEAM INDICATION WITH A DL-RELATED DCI FORMAT

(71) Applicant: Samsung Electronics Co., Ltd., Suwon-si (KR)

(72) Inventors: Emad N. Farag, Flanders, NJ (US); Eko Onggosanusi, Coppell, TX (US); Md. Saifur Rahman, Plano, TX (US)

(21) Appl. No.: 17/653,261

(22) Filed: Mar. 2, 2022

Related U.S. Application Data
(60) Provisional application No. 63/156,796, filed on Mar. 4, 2021.
(60) Provisional application No. 63/157,276, filed on Mar. 5, 2021.
(60) Provisional application No. 63/158,649, filed on Mar. 9, 2021.
(60) Provisional application No. 63/279,993, filed on Nov. 16, 2021.

(51) Int. Cl. H04W 72/04; H04L 1/18

(52) U.S. Cl. CPC H04W 72/042; H04L 1/1861; H04W 72/046

(57) ABSTRACT

Methods and apparatuses for beam indication with a downlink (DL)-related downlink control information (DCI) format in a wireless communication system. A method of operating a user equipment (UE) includes receiving configuration information for a list of transmission configuration indication (TCI) states; receiving TCI state code points activated via a medium access control-control element (MAC CE); and receiving a downlink control information (DCI) format indicating at least one of the activated TCI state code points. The DCI format does not include a downlink (DL) assignment and includes fields set to a bit pattern. The method further includes determining a TCI state to apply based on the at least one indicated TCI state code point; updating, based on the determined TCI state, quasi-co-location (QCL) assumption or spatial filters; and at least one of receiving based on the updated QCL assumption and transmitting based on the updated spatial filters.

### CROSS-REFERENCE TO RELATED APPLICATIONS AND CLAIM OF PRIORITY

The present application claims priority to:
U.S. Provisional Patent Application No. 63/156,796, filed on Mar. 4, 2021;
U.S. Provisional Patent Application No. 63/157,276, filed on Mar. 5, 2021;
U.S. Provisional Patent Application No. 63/158,649, filed on Mar. 9, 2021; and
U.S. Provisional Patent Application No. 63/279,993, filed on Nov. 16, 2022. The content of the above-identified patent documents are incorporated herein by reference.

### TECHNICAL FIELD

The present disclosure relates generally to wireless communication systems and, more specifically, the present disclosure relates to a beam indication with a downlink (DL)-related downlink control information (DCI) format in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a beam indication with a DL-related DCI format in a wireless communication system.

In one embodiment, a user equipment (UE) is provided. The UE includes a transceiver configured to: receive configuration information for a list of transmission configuration indication (TCI) states, receive TCI state code points activated via a medium access control-control element (MAC CE), and receive a downlink control information (DCI) format indicating at least one of the activated TCI state code points. The DCI format is DCI format 1_1 or DCI format 1_2. The DCI format does not include a downlink (DL) assignment. The DCI format includes fields set to a bit pattern. The UE further includes a processor operably coupled to the transceiver. The processor is configured to: determine whether the DCI format is successfully received, determine a TCI state to apply based on the at least one indicated TCI state code point, and update, based on the determined TCI state, (i) quasi-co-location (QCL) assumption for DL channels and signals or (ii) spatial filters for uplink (UL) channels and signals. The transceiver is further configured to transmit hybrid automatic repeat request acknowledgement (HARQ-ACK) feedback as a positive acknowledgment (ACK) in response to a determination that the DCI format is successfully received and at least one of (i) receive the DL channels and signals based on the updated QCL assumption and (ii) transmit the UL channels and signals based on the updated spatial filters.

In another embodiment, a base station (BS) is provided. The BS includes a transceiver configured to: transmit configuration information for a list of TCI states, transmit TCI state code points activated via a MAC CE. The BS further includes a processor operably coupled to the transceiver. The processor is configured to determine at least one TCI state code point from the activated TCI state code points for indication to a UE. The transceiver is further configured to transmit a DCI format indicating the at least one determined TCI state code point and receive HARQ-ACK feedback. The DCI format is DCI format 1_1 or DCI format 1_2. The DCI format does not include a downlink (DL) assignment. The DCI format includes fields set to a bit pattern. The processor is further configured to, if a positive ACK is received in the HARQ-ACK feedback, update, based on the at least one determined TCI state code point, (i) QCL assumption for DL channels and signals or (ii) spatial filters for uplink UL channels and signals. The transceiver is further configured to at least one of (i) transmit the DL channels and signals based on the updated QCL assumption and (ii) receive the UL channels and signals based on the updated spatial filters.

In yet another embodiment, a method of operating a UE is provided. The method includes receiving configuration information for a list of TCI states; receiving TCI state ode points activated via a MAC CE; and receiving a DCI format indicating at least one of the activated TCI state code points. The DCI format is DCI format 1_1 or DCI format 1_2. The DCI format does not include a DL assignment. The DCI format includes fields set to a bit pattern. The method further includes determining whether the DCI format is successfully received; determining a TCI state to apply based on the at least one indicated TCI state code point; updating, based on the determined TCI state, (i) QCL assumption for DL channels and signals or (ii) spatial filters for UL channels and signals; transmitting HARQ-ACK feedback as a positive ACK in response to determining that the DCI format is successfully received; and at least one of (i) receiving the DL channels and signals based on the updated QCL assumption and (ii) transmitting the UL channels and signals based on the updated spatial filters.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of DL multi beam operation according to embodiments of the present disclosure;

FIG. 9 illustrates an example of DL multi beam operation according to embodiments of the present disclosure;

FIG. 10 illustrates an example of UL multi beam operation according to embodiments of the present disclosure;

FIG. 11 illustrates an example of UL multi beam operation according to embodiments of the present disclosure;

FIG. 12 illustrates an example of TCI-DCI with beam indication information and HARQ-ACK feedback according to embodiments of the present disclosure;

FIG. 13 illustrates an example of components of DCI format according to embodiments of the present disclosure;

FIG. 14 illustrates another example of components of DCI format according to embodiments of the present disclosure;

FIG. 15 illustrates an example of a beam based on the HARQ-ACK feedback associated with a DCI transmission with the DL-Related DCI according to embodiments of the present disclosure;

FIG. 16 illustrates an example of a gNB and UE procedure according to embodiments of the present disclosure;

FIG. 17 illustrates an example of a beam the DL-Related DCI according to embodiments of the present disclosure;

FIG. 18 illustrates another example of a beam the DL-Related DCI according to embodiments of the present disclosure;

FIG. 19 illustrates an example of a gNB and UE procedure according to embodiments of the present disclosure;

FIG. 20 illustrates an example of beam based on the HARQ-ACK feedback associated with the PDSCH transmission associated with the DL-Related DCI according to embodiments of the present disclosure;

FIG. 21 illustrates an example of a gNB and UE procedure according to embodiments of the present disclosure;

FIG. 22 illustrates an example of beam based on the HARQ-ACK feedback associated with a DCI transmission with the DL-Related DCI according to embodiments of the present disclosure; and

FIG. 23 illustrates an example of a gNB and UE procedures according to embodiments of the present disclosure.

### DETAILED DESCRIPTION

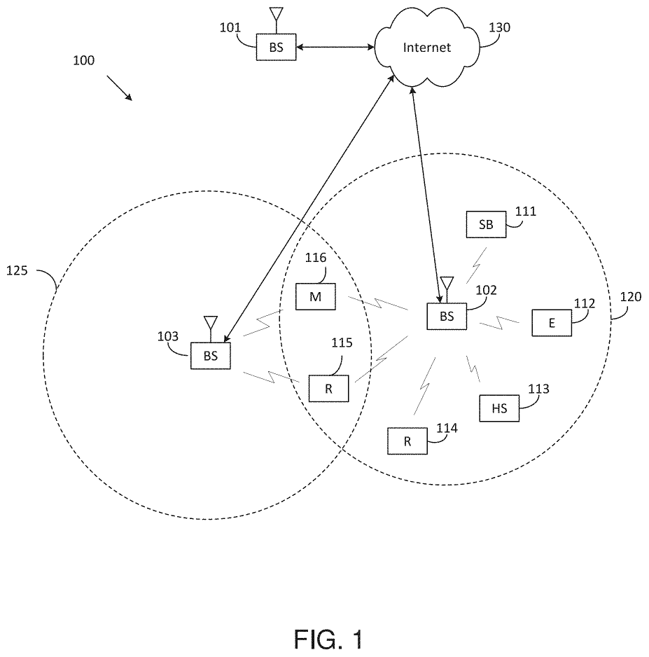

FIG. 1 through FIG. 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.8.0, “NR; Physical channels and modulation”; 3GPP TS 38.212 v16.8.0, “NR; Multiplexing and Channel coding”; 3GPP TS 38.213 v16.8.0, “NR; Physical Layer Procedures for Control”; 3GPP TS 38.214 v16.8.0, “NR; Physical Layer Procedures for Data”; 3GPP TS 38.321 v16.7.0, “NR; Medium Access Control (MAC) protocol specification”; and 3GPP TS 38.331 v16.7.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a beam indication with a DL-related DCI format with no DL assignment in a wireless communication system. In certain embodiments, and one or more of the gNBs 101-103 includes circuitry, programing, or a combination thereof, for a beam indication with a DL-related DCI format with no DL assignment in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

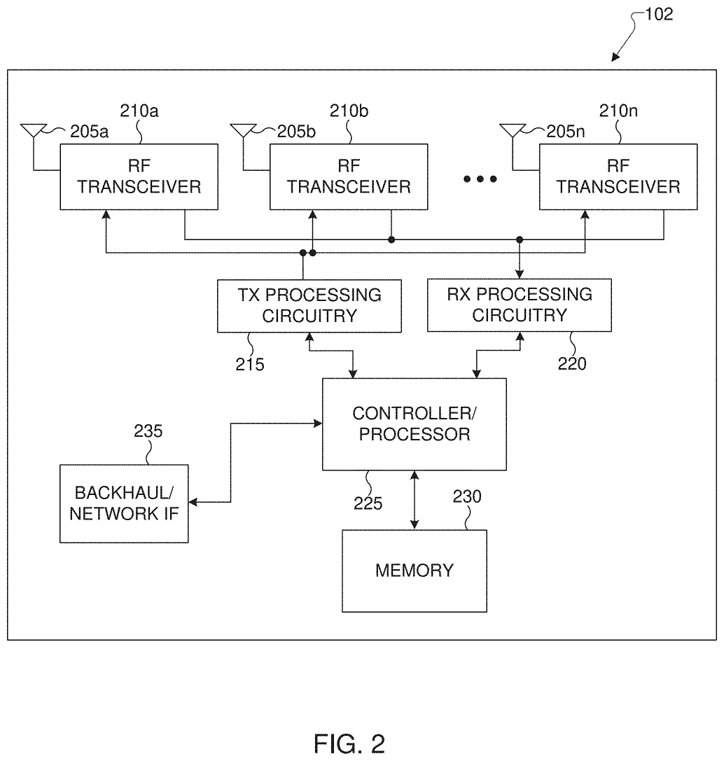

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support a beam indication with a DL-related DCI format with no DL assignment in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

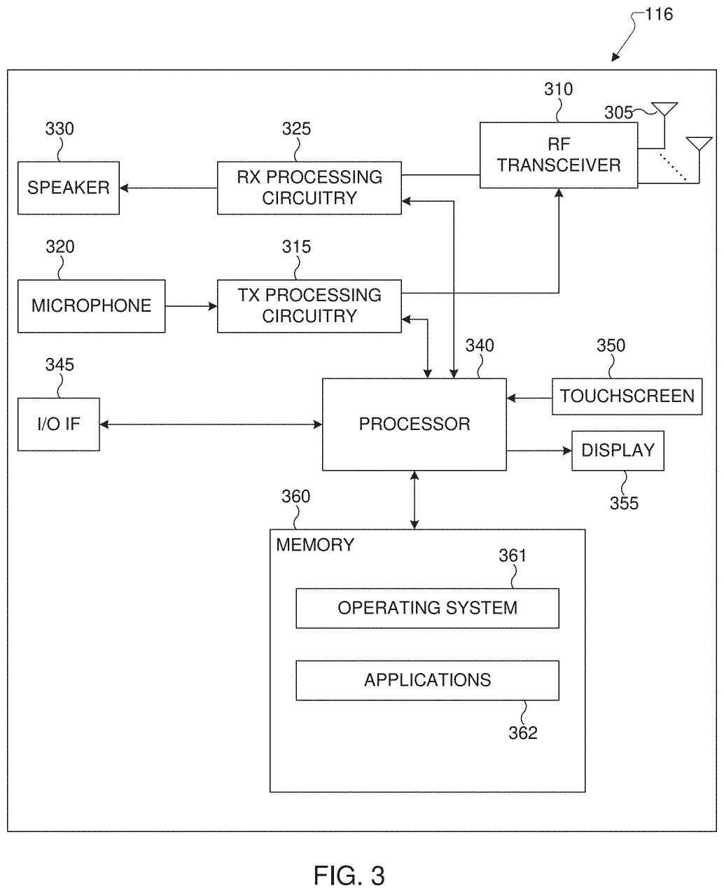

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for a beam indication with a DL-related DCI format with no DL assignment in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 30 KHz or 15 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A DCI format that can be used for DL assignments to schedule PDSCH transmissions can be DCI format 1_0, DCI format 1_1 or DCI format 1_2. TABLE 1, 2, and 3 provide the fields of DCI format 1_0, DCI format 1_1 and DCI format 1_2.

TABLE 1
DCI format 1_0

| Field | Description |
|---|---|
| Identifier for DCI formats | Value 1 to indicate DL DCI format |
| Frequency domain | |
| resource assignment | |
| Time domain | Described in clause 5.1.2.1 of TS 38.214. |
| resource assignment | Index to determine slot offset of PDSCH |
| | and slot-length indicator value |
| | (SLIV) of PDSCH |
| VRB-to-PRB mapping | 0 for non-interleaved, 1 for interleaved |
| Modulation and | |
| coding scheme | |
| New data indicator | |
| Redundancy version | |
| HARQ process number | |
| Downlink assignment index | 2 bits for counter DAI |
| TPC command for | See clause 7.2.1 of TS 38.213 |
| scheduled PUCCH | |
| PUCCH resource indicator | See clause 9.2.3 of TS 38.213 |
| PDSCH-to-HARQ feedback | See clause 9.2.3 of TS 38.213 |
| timing indicator | |

TABLE 2
DCI format 1_1

| Field | Description |
|---|---|
| Identifier for | Value 1 to indicate DL DCI format |
| DCI formats | |
| Carrier indicator | Described in clause 10.1 of TS 38.213 |
| Bandwidth part | Number of DL BWP excluding initial |
| indicator | DL BWP |
| Frequency domain | For resource allocation Type 0: Bitmap |
| resource assignment | For resource allocation Type 1: RIV |
| | Dynamic switch: MSB indicates resource |
| | allocation type |
| Time domain | Described in clause 5.1.2.1 of TS 38.214. |
| resource assignment | Index to determine slot offset of PDSCH |
| | and slot-length indicator value |
| | (SLIV) of PDSCH |
| VRB-to-PRB mapping | 0 for non-interleave, 1 for interleaved |
| PRB bundling size | 1 bit if prb-BundlingType is set to |
| indicator | dynamicBundling otherwise 0 bits. See |
| | clause 5.1.2.3 of TS 38.214 |
| Rate matching indicator | See clause 5.1.4.1 of TS 38.214 |
| ZP CSI-RS trigger | Size depends on a number of ZP CSI-RS |
| | resource sets. See clause 5.1.4.2 |
| For TB1: Modulation | Modulation and Coding scheme for TB1. |
| and coding scheme | See clause 5.1.3.1 of TS 38.214. |
| For TB1: New | New data indicator for TB1. |
| data indicator | |
| For TB1: Redundancy | Redundancy version for TB1: |
| version | “00” [symbol] rv_{id} = 0, |
| | “01” [symbol] rv_{id} = 1, |
| | “10” [symbol] rv_{id} = 2, |
| | “11” [symbol] rv_{id} = 3 |
| For TB2: Modulation | Modulation and Coding scheme for TB2. |
| and coding scheme | See clause 5.1.3.1 of TS 38.214. |
| For TB2: New | New data indicator for TB2. |
| data indicator | |
| For TB2: Redundancy | Redundancy version for TB2: |
| version | “00” [symbol] rv_{id} = 0, |
| | “01” [symbol] rv_{id} = 1, |
| | “10” [symbol] rv_{id} = 2, |
| | “11” [symbol] rv_{id} = 3 |
| HARQ process number | |
| Downlink assignment | 2 bits total DAI, if more than one serving |
| index (DAI) | cell with dynamic codebook configured. |
| | 2 bits counter DAI, if dynamic codebook |
| | is configured. |
| TPC command for | See clause 7.2.1 of TS 38.213 |
| scheduled PUCCH | |
| PUCCH resource | See clause 9.2.3 of TS 38.213 |
| indicator | |
| PDSCH-to-HARQ feedback | See clause 9.2.3 of TS 38.213 |
| timing indicator | |
| One-shot HARQ- | Introduced in release 16 |
| ACK request | |
| PDSCH group index | Introduced in release 16 |
| New feedback indicator | Introduced in release 16 |
| Number of requested | Introduced in release 16 |
| PDSCH group(s) | |
| Antenna ports | |
| Transmission | 0 bit if higher layer parameter |
| configuration | tci-PresentInDCI is not enabled; |
| indication | otherwise, 3 bits. |
| | See clause 5.1.5 of TS 38.214 |
| SRS request | |
| CBG transmission | 0 bit if higher layer parameter |
| information | codeBlockGroupTransmission for PDSCH |
| | is not configured, otherwise, 2, 4, 6, |
| | or 8 bits. See clause 5.1.7 in 38.214 |
| CBG flushing out | 1 bit if higher layer parameter |
| information | codeBlockGroupFlushIndicator is configured |
| | as “TRUE,” 0 bit otherwise. |
| DMRS sequence | |
| initialization | |
| Priority indicator | Introduced in release 16. |
| | 0 bit if higher layer parameter |
| | priorityIndicatorForDCI-Format1-1 |
| | is not configured; otherwise, 1 bit. |
| | See Clause 9 of TS 38.213 |
| ChannelAccess-Cpext | Introduced in release 16 |
| Minimum applicable | Introduced in release 16 |
| scheduling | |
| offset indicator | |
| Scell dormancy | Introduced in release 16. |
| indication | 0 bit if higher layer parameter |
| | dormancyGroupWithinActiveTime |
| | is not configured; otherwise, 1, 2, |
| | 3, 4 or 5 bits bitmap determined |
| | according to higher layer parameter |
| | dormancyGroupWithinActiveTime |

TABLE 3
DCI format 1_2

| Field | Description |
|---|---|
| Identifier for DCI formats | Value 1 to indicate DL DCI format |
| Carrier indicator | Described in clause 10.1 of TS 38.213 |
| Bandwidth part | Number of DL BWP excluding initial |
| indicator | DL BWP |
| Frequency domain | For resource allocation Type 0: Bitmap |
| resource assignment | For resource allocation Type 1: RIV |
| | Dynamic switch: MSB indicates resource |
| | allocation type |
| Time domain | Described in clause 5.1.2.1 of TS 38.214. |
| resource assignment | Index to determine slot offset and |
| | slot-length indicator value (SLIV) |
| VRB-to-PRB mapping | 0 for non-interleaved, 1 for interleaved |
| PRB bundling size indicator | 1 bit if prb-BundlingType is set to |
| | dynamicBundling otherwise 0 bits. |
| | See clause 5.1.2.3 of TS 38.214 |
| Rate matching indicator | See clause 5.1.4.1 of TS 38.214 |
| ZP CSI-RS trigger | Size depends on a number of ZP CSI-RS |
| | resource sets. See clause 5.1.4.2 |
| Modulation and | |
| coding scheme | |
| New data indicator | |
| Redundancy version | |
| HARQ process number | |
| Downlink assignment index | |
| TPC command for | See clause 7.2.1 of TS 38.213 |
| scheduled PUCCH | |
| PUCCH resource indicator | See clause 9.2.3 of TS 38.213 |
| PDSCH-to-HARQ feedback | See clause 9.2.3 of TS 38.213 |
| timing indicator | |
| Antenna ports | |
| Transmission configuration | |
| indication | |
| SRS request | |
| DMRS sequence initialization | |
| Priority indicator | 0 bit if higher layer parameter |
| | priorityIndicatorForDCI-Format1-1 is not |
| | configured; otherwise, 1 bit. See Clause |
| | 9 of TS 38.213 |

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective PUSCH or a PUCCH. A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in its buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission.

A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random access channel (PRACH).

3GPP Rel-17 introduced the unified TCI framework, where a unified or master or main or indicated TCI state is signaled or indicated to the UE. The unified or master or main or indicated TCI state can be one of: (1) In case of joint TCI state indication, wherein a same beam is used for DL and UL channels, a joint TCI state that can be used at least for UE-dedicated DL channels and UE-dedicated UL channels. (2) In case of separate TCI state indication, wherein different beams are used for DL and UL channels, a DL TCI state can be used at least for UE-dedicated DL channels. (3) In case of separate TCI state indication, wherein different beams are used for DL and UL channels, a UL TCI state can be used at least for UE-dedicated UL channels.

The unified (master or main or indicated) TCI state is a DL or Joint TCI state of UE-dedicated reception on PDSCH/PDCCH and the CSI-RS applying the indicated TCI state and/or an UL TCI state or a joint TCI state for dynamic-grant/configured-grant based PUSCH, PUCCH, and SRS applying the indicated TCI state.

The unified TCI framework applies to intra-cell beam management, wherein, the TCI states have a source RS that is directly or indirectly associated, through a quasi-co-location relation (QCL) assumption, e.g., spatial relation, with an SSB of a serving cell. The unified TCI state framework also applies to inter-cell beam management, wherein a TCI state can have a source RS that is directly or indirectly associated, through a quasi-co-location relation, e.g., spatial relation, with an SSB of cell that has a PCI different from the PCI of the serving cell.

Quasi-co-location (QCL) relation (QCL assumption), can be quasi-location with respect to one or more of the following relations [38.214—section 5.1.5]: (1) Type A, {Doppler shift, Doppler spread, average delay, delay spread} (2) Type B, {Doppler shift, Doppler spread} (3) Type C, {Doppler shift, average delay} (4) Type D, {Spatial Rx parameter}.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

In the present disclosure, a beam is determined by either of: (1) a TCI state, that establishes a quasi-colocation (QCL) relationship (QCL assumption) between a source reference signal (e.g., SSB and/or CSI-RS) and a target reference signal; and (2) a spatial relation information that establishes an association to a source reference signal, such as SSB or CSI-RS or SRS. In either case, the ID of the source reference signal identifies the beam.

The TCI state and/or the spatial relation reference RS can determine a spatial Rx filter or quasi-co-location (QCL) properties (QCL assumption) for reception of downlink channels at the UE, or a spatial Tx filter for transmission of uplink channels from the UE.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

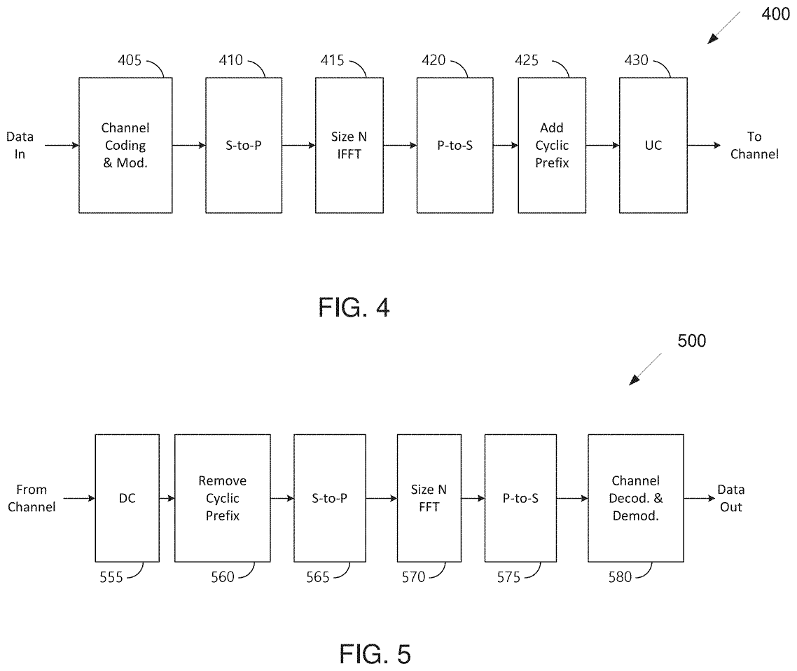

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

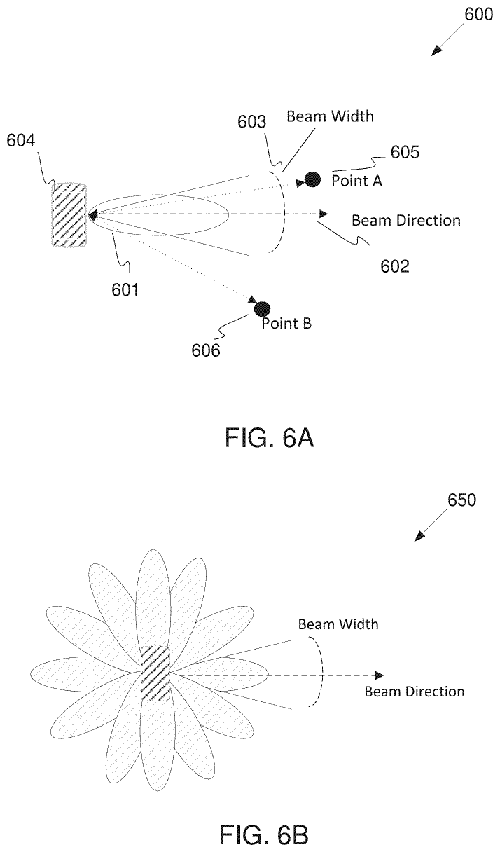

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

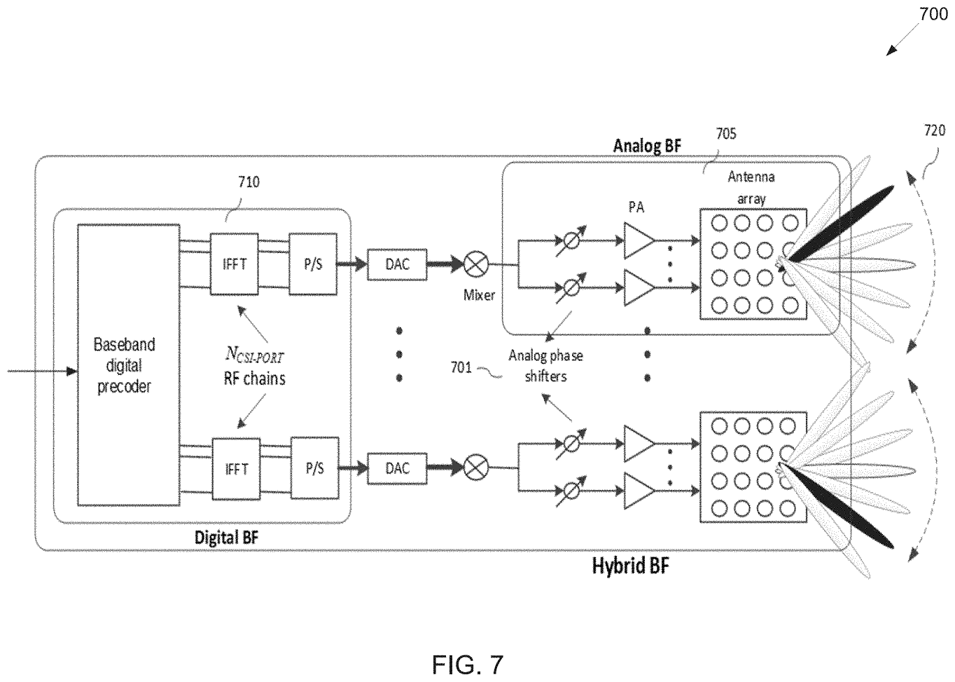

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

As described in U.S. patent application Ser. No. 17/148,517 filed on Jan. 13, 2021, which is incorporated by reference in its entirety, a TCI DCI can be a dedicated channel for beam indication information, i.e., a purposed designed DL channel for beam indication. Beam indication information can also be included in a DL-related DCI or in an UL-related DCI. In this disclosure, more detailed aspects related to the configuration and signaling of beam indication relaying on L1 signaling is provided as well as higher layer configuration and signaling.

In release 15/16 a common framework is shared for CSI and beam management, while the complexity of such framework is justified for CSI in FR1, it makes beam management procedures rather cumbersome, and less efficient in FR2. Efficiency here refers to overhead associated with beam management operations and latency for reporting and indicating new beams.

Furthermore, in release 15 and release 16, the beam management framework is different for different channels. This increases the overhead of beam management, and could lead to less robust beam-based operation. For example, for PDCCH the TCI state (used for beam indication), is updated through MAC CE signaling. While the TCI state of PDSCH can be updated through a DL DCI carrying the DL assignment with codepoints configured by MAC CE, or the PDSCH TCI state can follow that of the corresponding PDCCH, or use a default beam indication. In the uplink direction, the spatialRelationInfo framework is used for beam indication for PUCCH and SRS, which is updated through RRC and MAC CE signaling. For PUSCH the SRI (SRS Resource Indicator), in an UL DCI with UL grants, can be used for beam indication. Having different beam indications and beam indication update mechanisms increases the complexity, overhead and latency of beam management, and could lead to less robust beam-based operation.

To reduce the latency and overhead of beam indication, L1 based beam indication has been proposed, wherein a TCI DCI is used for beam indication. A TCI DCI can be a dedicated channel for beam indication information, i.e. a purposed designed DL channel for beam indication. Beam indication information can also be included in a DL-related DCI or in an UL-related DCI. A DL related DCI is usually transmitted when there is a DL assignment (e.g., DCI format 1_0 or DCI format 1_1 or DCI format 1_2). In some cases, there could no dynamic downlink scheduling for an extended time period. For example, if there is DL data is transmitted by Semi-Persistent Scheduling (SPS) and in case of UL heavy traffic with no or little DL traffic. In these scenarios, if beam indication is signaled by a DL-related DCI format there will be no beam updates for extended time periods, which negatively impacts performance. To alleviate this, a DL-related DCI format for beam indication (e.g. TCI state or spatial relation) and without DL assignment has been proposed. In this disclosure we consider detailed design aspects of a DL-related DCI format for beam indication (e.g. TCI state or spatial relation) and without DL assignment.

To streamline beam management procedures, a TCI state can be indicated in a DCI with or without a DL assignment. The DCI is acknowledged in HARQ-ACK carried in an uplink channel (e.g., PUCCH or PUSCH). After the HARQ-ACK with a positive acknowledgment of the TCI state is transmitted, by a beam application delay, the TCI state received in the DCI is applied. In this disclosure, we consider aspects related to the configuration of the beam application time when there are multiple component carriers (CCs) and/or multiple BWPs.

The present disclosure builds on the beam indication design as described in U.S. patent application Ser. No. 17/444,556 filed Aug. 5, 2021 which is incorporated by reference in its entirety.

In the following, both FDD and TDD are considered as a duplex method for DL and UL signaling.

Although exemplary descriptions and embodiments to follow assume OFDM or OFDMA, the present disclosure can be extended to other OFDM-based transmission waveforms or multiple access schemes such as filtered OFDM (F-OFDM).

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

A “reference RS” corresponds to a set of characteristics of a DL beam or an UL TX beam, such as a direction, a precoding/beamforming, a number of ports, and so on. For instance, for DL, as the UE receives a reference RS index/ID, for example through a field in a DCI format, that is represented by a TCI state, the UE applies the known characteristics of the reference RS to associated DL reception. The reference RS can be received and measured by the UE (for example, the reference RS is a downlink signal such as NZP CSI-RS and/or SSB) and the UE can use the result of the measurement for calculating a beam report (in Rel-15 NR, a beam report includes at least one L1-RSRP accompanied by at least one CRI). Using the received beam report, the NW/gNB can assign a particular DL TX beam to the UE. A reference RS can also be transmitted by the UE (for example, the reference RS is an uplink signal such as SRS). As the NW/gNB receives the reference RS from the UE, the NW/gNB can measure and calculate information used to assign a particular DL TX beam to the UE. This option is applicable at least when there is DL-UL beam pair correspondence.

In another instance, for UL transmissions, a UE can receive a reference RS index/ID in a DCI format scheduling an UL transmission such as a PUSCH transmission and the UE then applies the known characteristics of the reference RS to the UL transmission. The reference RS can be received and measured by the UE (for example, the reference RS is a downlink signal such as NZP CSI-RS and/or SSB) and the UE can use the result of the measurement to calculate a beam report. The NW/gNB can use the beam report to assign a particular UL TX beam to the UE. This option is applicable at least when DL-UL beam pair correspondence holds. A reference RS can also be transmitted by the UE (for example, the reference RS is an uplink signal such as SRS or DMRS). The NW/gNB can use the received reference RS to measure and calculate information that the NW/gNB can use to assign a particular UL TX beam to the UE.

The reference RS can be triggered by the NW/gNB, for example via DCI in case of aperiodic (AP) RS, or can be configured with a certain time-domain behavior, such as a periodicity and offset in case of periodic RS, or can be a combination of such configuration and activation/deactivation in case of semi-persistent RS.

For mmWave bands (or FR2) or for higher frequency bands (such as >52.6 GHz) where multi-beam operation is especially relevant, a transmission-reception process includes a receiver selecting a receive (RX) beam for a given TX beam. For DL multi-beam operation, a UE selects a DL RX beam for every DL TX beam (that corresponds to a reference RS). Therefore, when DL RS, such as CSI-RS and/or SSB, is used as reference RS, the NW/gNB transmits the DL RS to the UE for the UE to be able to select a DL RX beam. In response, the UE measures the DL RS, and in the process selects a DL RX beam, and reports the beam metric associated with the quality of the DL RS.

In this case, the UE determines the TX-RX beam pair for every configured (DL) reference RS. Therefore, although this knowledge is unavailable to the NW/gNB, the UE, upon receiving a DL RS associated with a DL TX beam indication from the NW/gNB, can select the DL RX beam from the information the UE obtains on all the TX-RX beam pairs. Conversely, when an UL RS, such as an SRS and/or a DMRS, is used as reference RS, at least when DL-UL beam correspondence or reciprocity holds, the NW/gNB triggers or configures the UE to transmit the UL RS (for DL and by reciprocity, this corresponds to a DL RX beam). The gNB, upon receiving and measuring the UL RS, can select a DL TX beam. As a result, a TX-RX beam pair is derived. The NW/gNB can perform this operation for all the configured UL RSs, either per reference RS or by “beam sweeping,” and determine all TX-RX beam pairs associated with all the UL RSs configured to the UE to transmit.

The following two embodiments (A-1 and A-2) are examples of DL multi-beam operations that utilize DL-TCI-state based DL beam indication. In the first example embodiment (A-1), an aperiodic CSI-RS is transmitted by the NW/gNB and received/measured by the UE. This embodiment can be used regardless of whether or not there is UL-DL beam correspondence. In the second example embodiment (A-2), an aperiodic SRS is triggered by the NW and transmitted by the UE so that the NW (or a gNB) can measure the UL channel quality for the purpose of assigning a DL RX beam. This embodiment can be used at least when there is UL-DL beam correspondence. Although aperiodic RS is considered in the two examples, a periodic or a semi-persistent RS can also be used.

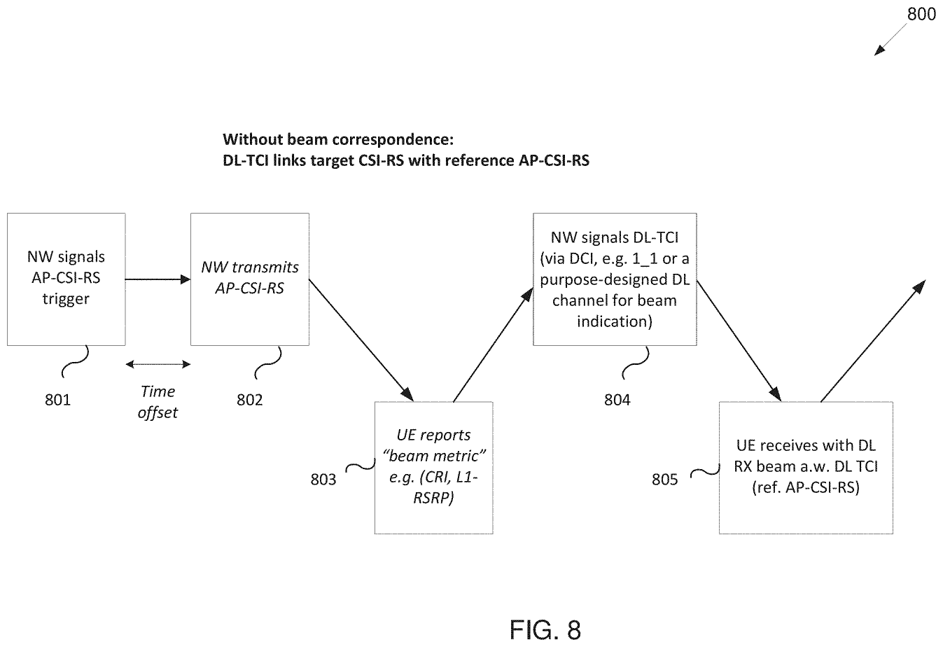

FIG. 8 illustrates an example of DL multi beam operation 800 according to embodiments of the present disclosure. An embodiment of the DL multi beam operation 800 shown in FIG. 8 is for illustration only.

In one example illustrated in FIG. 8 (embodiment A-1), a DL multi-beam operation 800 starts with the gNB/NW signaling to a UE an aperiodic CSI-RS (AP-CSI-RS) trigger or indication (step 801). This trigger or indication can be included in a DCI and indicate transmission of AP-CSI-RS in a same (zero time offset) or in a later slot/sub-frame (>0 time offset). For example, the DCI can be related to scheduling of a DL reception or an UL transmission and the CSI-RS trigger can be either jointly or separately coded with a CSI report trigger. Upon receiving the AP-CSI-RS transmitted by the gNB/NW (step 802), the UE measures the AP-CSI-RS and calculates and reports a “beam metric” that indicates a quality of a particular TX beam hypothesis (step 803). Examples of such beam reporting are a CSI-RS resource indicator (CRI), or a SSB resource indicator (SSB-RI), coupled with an associated L1-RSRP/L1-RSRQ/L1-SINR/CQI.

Upon receiving the beam report from the UE, the gNB/NW can use the beam report to select a DL RX beam for the UE and indicate the DL RX beam selection (step 804) using a TCI-state field in a DCI format such as a DCI format scheduling a PDSCH reception by the UE. In this case, a value of the TCI-state field indicates a reference RS, such as an AP-CSI-RS, representing the selected DL TX beam (by the gNB/NW). In addition, the TCI-state can also indicate a “target” RS, such as a. CSI-RS, that is linked to the reference RS, such as an AP-CSI-RS. Upon successfully decoding the DCI format providing the TCI-state, the UE selects an DL RX beam and performs DL reception, such as a PDSCH reception, using the DL RX beam associated with the reference CSI-RS (step 805).

Alternatively, the gNB/NW can use the beam report to select a DL RX beam for the UE and indicate to the UE the selected DL RX beam (step 804) using a value of a TCI-state field in a purpose-designed DL channel for beam indication. A purpose-designed DL channel for beam indication can be UE-specific or for a group of UEs. For example, a UE-specific DL channel can be a PDCCH that a UE receives according to a UE-specific search space (USS) while a UE-group common DL channel can be a PDCCH that a UE receives according to a common search space (CSS). In this case, the TCI-state indicates a reference RS, such as an AP-CSI-RS, representing the selected DL TX beam (by the gNB/NW). In addition, the TCI-state can also indicate a “target” RS, such as a CSI-RS, that is linked to the reference RS, such as an AP-CSI-RS. Upon successfully decoding the purpose-designed DL channel for beam indication with the TCI state, the UE selects a DL RX beam and performs DL reception, such as a PDSCH reception, using the DL RX beam associated with the reference CSI-RS (step 805).

For this embodiment (A-1), as described above, the UE selects a DL RX beam using an index of a reference RS, such as an AP-CSI-RS, that is provided via the TCI state field, for example in a DCI format. In this case, the CSI-RS resources or, in general, the DL RS resources including CSI-RS, SSB, or a combination of the two, that are configured to the UE as the reference RS resources can be linked to (associated with) a “beam metric” reporting such as CRI/L1-RSRP or L1-SINR.

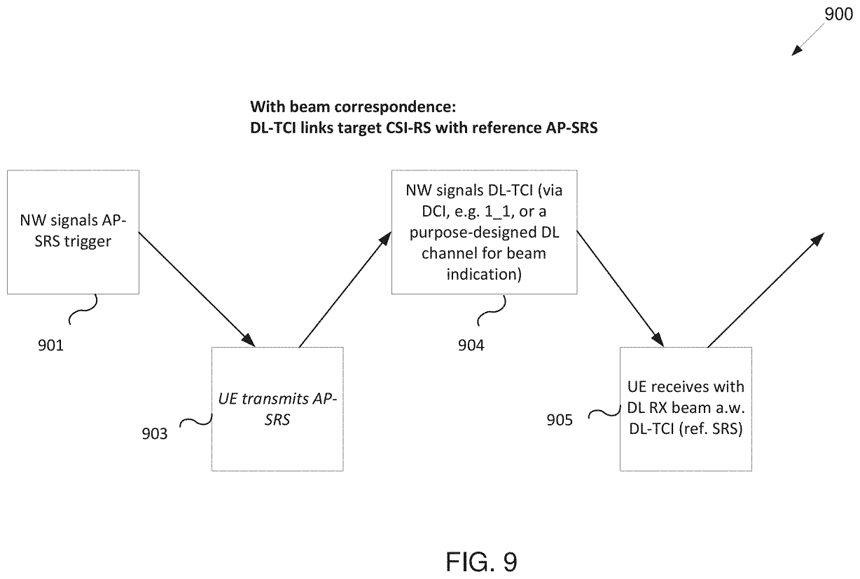

FIG. 9 illustrates an example of DL multi beam operation 900 according to embodiments of the present disclosure. An embodiment of the DL multi beam operation 900 shown in FIG. 9 is for illustration only.

In another example illustrated in FIG. 9 (embodiment A-2), an DL multi-beam operation 900 starts with the gNB/NW signaling to a UE an aperiodic SRS (AP-SRS) trigger or request (step 901). This trigger can be included in a DCI format such as for example a DCI format scheduling a PDSCH reception or a PUSCH transmission. Upon receiving and decoding the DCI format with the AP-SRS trigger (step 902), the UE transmits an SRS (AP-SRS) to the gNB/NW (step 903) so that the NW (or gNB) can measure the UL propagation channel and select a DL RX beam for the UE for DL (at least when there is beam correspondence).

The gNB/NW can then indicate the DL RX beam selection (step 904) through a value of a TCI-state field in a DCI format, such as a DCI format scheduling a PDSCH reception. In this case, the TCI state indicates a reference RS, such as an AP-SRS, representing the selected DL RX beam. In addition, the TCI state can also indicate a “target” RS, such as a CSI-RS, that is linked to the reference RS, such as an AP-SRS. Upon successfully decoding the DCI format providing the TCI state, the UE performs DL receptions, such as a PDSCH reception, using the DL RX beam indicated by the TCI-state (step 905).

Alternatively, the gNB/NW can indicate the DL RX beam selection (step 904) to the UE using a TCI-state field in a purpose-designed DL channel for beam indication. A purpose-designed DL channel for beam indication can be UE-specific or for a group of UEs. For example, a UE-specific DL channel can be a PDCCH that a UE receives according to a UE-specific search space (USS) while a UE-group common DL channel can be a PDCCH that a UE receives according to a common search space (CSS). In this case, the TCI-state indicates a reference RS, such as an AP-SRS, representing the selected DL RX beam. In addition, the TCI-state can also indicate a “target” RS, such as a CSI-RS, that is linked to the reference RS, such as an AP-SRS. Upon successfully decoding a purpose-designed DL channel for beam indication with the TCI-state, the UE performs DL reception, such as a PDSCH reception, with the DL RX beam indicated by the TCI-state (step 905).

For this embodiment (A-2), as described above, the UE selects the DL RX beam based on the UL TX beam associated with the reference RS (AP-SRS) index signaled via the TCI-state field.

Similarly, for UL multi-beam operation, the gNB selects an UL RX beam for every UL TX beam that corresponds to a reference RS. Therefore, when an UL RS, such as an SRS and/or a DMRS, is used as a reference RS, the NW/gNB triggers or configures the UE to transmit the UL RS that is associated with a selection of an UL TX beam. The gNB, upon receiving and measuring the UL RS, selects an UL RX beam. As a result, a TX-RX beam pair is derived. The NW/gNB can perform this operation for all the configured reference RSs, either per reference RS or by “beam sweeping,” and determine all the TX-RX beam pairs associated with all the reference RSs configured to the UE.

Conversely, when a DL RS, such as a CSI-RS and/or an SSB, is used as reference RS (at least when there is DL-UL beam correspondence or reciprocity), the NW/gNB transmits the RS to the UE (for UL and by reciprocity, this RS also corresponds to an UL RX beam). In response, the UE measures the reference RS (and in the process selects an UL TX beam) and reports the beam metric associated with the quality of the reference RS. In this case, the UE determines the TX-RX beam pair for every configured (DL) reference RS. Therefore, although this information is unavailable to the NW/gNB, upon receiving a reference RS (hence an UL RX beam) indication from the NW/gNB, the UE can select the UL TX beam from the information on all the TX-RX beam pairs.

The following two embodiments (B-1 and B-2) are examples of UL multi-beam operations that utilize TCI-based UL beam indication after the network (NW) receives a transmission from the UE. In the first example embodiment (B-1), a NW transmits an aperiodic CSI-RS and a UE receives and measures the CSI-RS. This embodiment can be used, for instance, at least when there is reciprocity between the UL and DL beam-pair-link (BPL). This condition is termed “UL-DL beam correspondence.”

In the second example embodiment (B-2), the NW triggers an aperiodic SRS transmission from a UE and the UE transmits the SRS so that the NW (or a gNB) can measure the UL channel quality for the purpose of assigning an UL TX beam. This embodiment can be used regardless of whether or not there is UL-DL beam correspondence. Although aperiodic RS is considered in these two examples, periodic or semi-persistent RS can also be used.

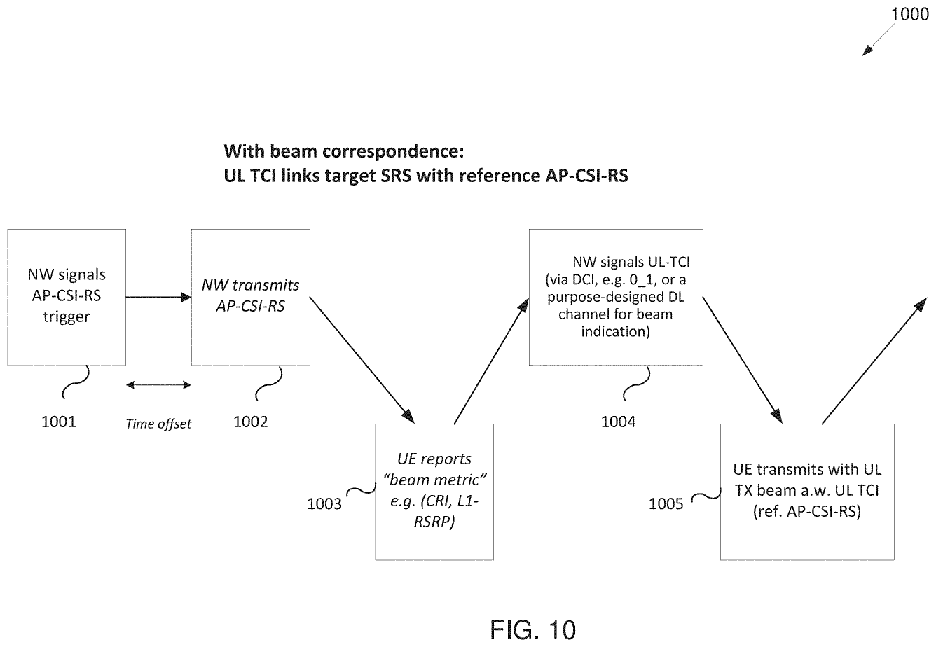

FIG. 10 illustrates an example of UL multi beam operation 1000 according to embodiments of the present disclosure. An embodiment of the UL multi beam operation 1000 shown in FIG. 10 is for illustration only.

In one example illustrated in FIG. 10 (embodiment B-1), an UL multi-beam operation 1000 starts with the gNB/NW signaling to a UE an aperiodic CSI-RS (AP-CSI-RS) trigger or indication (step 1001). This trigger or indication can be included in a DCI format, such as a DCI format scheduling a PDSCH reception to the UE or a PUSCH transmission from the UE and can be either separately or jointly signaled with an aperiodic CSI request/trigger, and indicate transmission of AP-CSI-RS in a same slot (zero time offset) or in a later slot/sub-frame (>0 time offset). Upon receiving the AP-CSI-RS transmitted by the gNB/NW (step 1002), the UE measures the AP-CSI-RS and, in turn, calculates and reports a “beam metric” (indicating quality of a particular TX beam hypothesis) (step 1003). Examples of such beam reporting are CSI-RS resource indicator (CRI) or SSB resource indicator (SSB-RI) together with an associated L1-RSRP/L1-RSRQ/L1-SINR/CQI.

Upon receiving the beam report from the UE, the gNB/NW can use the beam report to select an UL TX beam for the UE and indicate the UL TX beam selection (step 1004) using a TCI-state field in a DCI format, such as a DCI format scheduling a PUSCH transmission from the UE. The TCI-state indicates a reference RS, such as an AP-CSI-RS, representing the selected UL RX beam (by the gNB/NW). In addition, the TCI-state can also indicate a “target” RS, such as a SRS, that is linked to the reference RS, such as an AP-CSI-RS. Upon successfully decoding the DCI format indicating the TCI-state, the UE selects an UL TX beam and performs UL transmission, such as a PUSCH transmission, using the UL TX beam associated with the reference CSI-RS (step 1005).

Alternatively, the gNB/NW can use the beam report to select an UL TX beam for the UE and indicate the UL TX beam selection (step 1004) to the UE using a value of a TCI-state field in a purpose-designed DL channel for beam indication. A purpose-designed DL channel for beam indication can be UE-specific or for a group of UEs. For example, a UE-specific DL channel can be a PDCCH that a UE receives according to a UE-specific search space (USS) while a UE-group common DL channel can be a PDCCH that a UE receives according to a common search space (CSS). In this case, the TCI-state indicates a reference RS, such as an AP-CSI-RS, representing the selected UL RX beam (by the gNB/NW). In addition, the TCI-state can also indicate a “target” RS, such as a SRS, that is linked to the reference RS, such as an AP-CSI-RS. Upon successfully decoding a purpose-designed DL channel providing a beam indication by the TCI-state, the UE selects an UL TX beam and performs UL transmission, such as a PUSCH transmission, using the UL TX beam associated with the reference CSI-RS (step 1005).

For this embodiment (B-1), as described above, the UE selects the UL TX beam based on the derived DL RX beam associated with the reference RS index signaled via the value of the TCI-state field. In this case, the CSI-RS resources or, in general, the DL RS resources including CSI-RS, SSB, or a combination of the two, that are configured for the UE as the reference RS resources can be linked to (associated with) “beam metric” reporting such as CRI/L1-RSRP or L1-SINR.

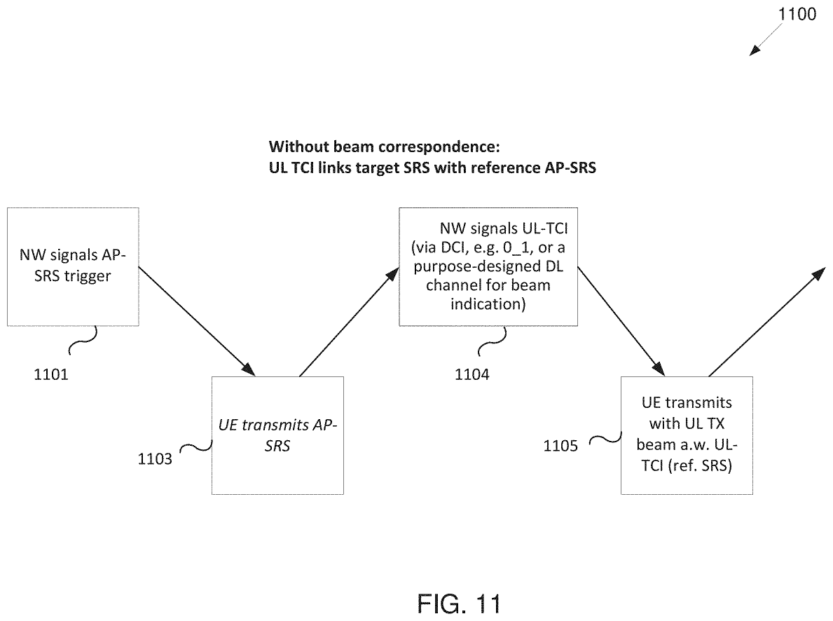

FIG. 11 illustrates an example of UL multi beam operation 1100 according to embodiments of the present disclosure. An embodiment of the UL multi beam operation 1100 shown in FIG. 11 is for illustration only.

In another example illustrated in FIG. 11 (embodiment B-2), an UL multi-beam operation 1100 starts with the gNB/NW signaling to a UE an aperiodic SRS (AP-SRS) trigger or request (step 1101). This trigger can be included in a DCI format, such as a DCI format scheduling a PDSCH reception or a PUSCH transmission. Upon receiving and decoding the DCI format with the AP-SRS trigger (step 1102), the UE transmits AP-SRS to the gNB/NW (step 1103) so that the NW (or a gNB) can measure the UL propagation channel and select an UL TX beam for the UE.

The gNB/NW can then indicate the UL TX beam selection (step 1104) using a value of the TCI-state field in the DCI format. In this case, the UL-TCI indicates a reference RS, such as an AP-SRS, representing the selected UL TX beam. In addition, the TCI-state can also indicate a “target” RS, such as a SRS, that is linked to the reference RS, such as an AP-SRS. Upon successfully decoding the DCI format providing a value for the TCI-state, the UE transmits, for example a PUSCH or a PUCCH, using the UL TX beam indicated by the TCI-state (step 1105).

Alternatively, a gNB/NW can indicate the UL TX beam selection (step 1104) to the UE using a value of a TCI-state field in a purpose-designed DL channel for beam indication. A purpose-designed DL channel for beam indication can be UE-specific or for a group of UEs. For example, a UE-specific DL channel can be a PDCCH that a UE receives according to a UE-specific search space (USS) while a UE-group common DL channel can be a PDCCH that a UE receives according to a common search space (CSS). In this case, the UL-TCI indicates a reference RS, such as an AP-SRS, representing the selected UL TX beam. In addition, the TCI-state can also indicate a “target” RS, such as a SRS, that is linked to the reference RS, such as an AP-SRS. Upon successfully decoding a purpose-designed DL channel for beam indication through a value of the TCI-state field, the UE transmits, such as a PUSCH or a PUCCH, using the UL TX beam indicated by the value of the TCI-state (step 1105).

For this embodiment (B-2), as described above, the UE selects the UL TX beam from the reference RS (in this case SRS) index signaled via the value of the TCI-state field.

In the following components, a TCI state is used for beam indication. It can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

For high-speed applications, L1/L2-centric inter-cell mobility has been provided in FeMIMO of 3GPP standard specification release 17, to reduce handover latency. A beam measurement report from a UE can include up to K beams associated with at least a non-serving cell, wherein for each beam the UE can report; a measured RS indicator and the beam metric (e.g., L1-RSRP, L3-RSRP, L1-SINR, etc.) associated with the measured RS indicator.

Upon receiving beam measurement reports with beam measurements from non-serving cells and/or the serving cells, the network can decide, based on the beam measurement reports to indicate a beam (e.g., a TCI state or a spatial relation) for non-serving cell for reception and/or transmission of DL and/or UL channels respectively.

A DL-related DCI format is a DCI format that can include a DL assignment, such as DCI format 1_0, DCI format 1_1 and DCI format 1_2.

As described in U.S. application Ser. No. 17/249,115 filed Feb. 19, 2021, which is incorporated by reference in its entirety, a DL related DCI without a DL assignment e.g., DCI format 1_0 or DCI format 1_1 or DCI format 1_2 can be used to convey a beam indication (e.g., a TCI state). The DCI format containing the TCI state can include a flag for indicating that the TCI format does not carry a DL assignment. Alternatively, the DCI format can include a special bit pattern of some of the existing fields to indicate that the DCI format does not carry a DL assignment. Alternatively, the DCI format can include a CRC scrambled with an RNTI for a DCI format that does not carry a DL assignment.

As described in U.S. patent application Ser. No. 17/305,050 filed Jun. 29, 2021, which is incorporated by reference in its entirety, a DCI format conveying beam indication triggers a HARQ-ACK feedback for confirmation of DCI format reception by the UE.

In the present disclosure, additional design aspects related to a DL-related DCI format with beam indication and without a DL assignment is provided.

In the following examples a TCI DCI is a downlink control channel transmission on a PDCCH channel carrying beam indication information e.g., TCI state information to one or multiple UEs. As described in U.S. application Ser. No. 17/148,517, a TCI DCI can be a dedicated channel for beam indication information, i.e., a purposed designed DL channel for beam indication. TCI DCI can also be a dedicated DCI (specified for the purpose of beam indication or TCI state update) transmitted via PDCCH. Beam indication information can also be included in a DL-related DCI or in an UL-related DCI.

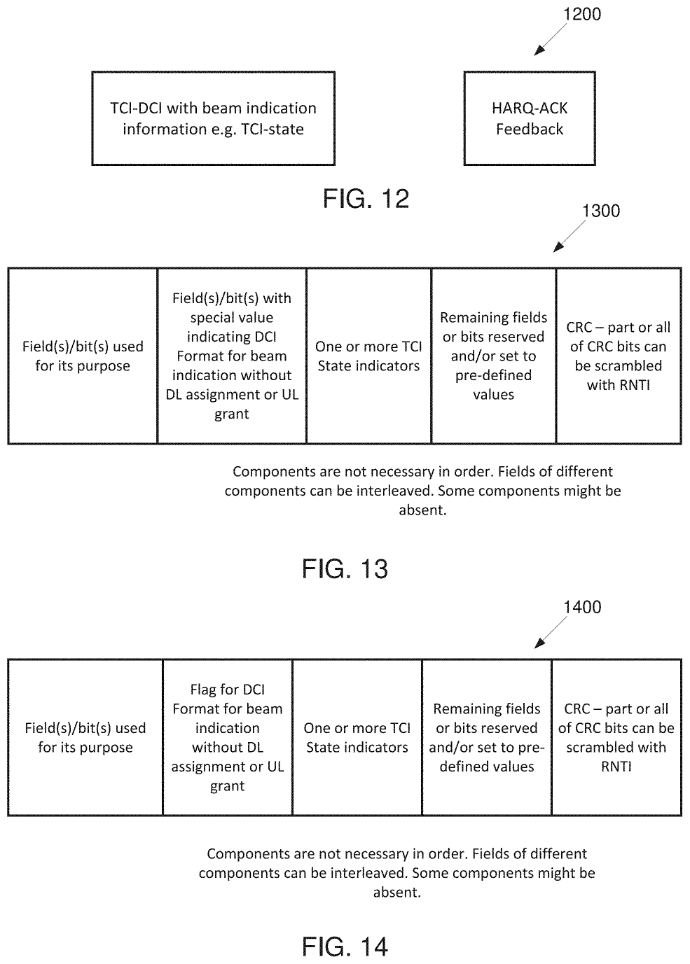

FIG. 12 illustrates an example of TCI-DCI with beam indication information and HARQ-ACK feedback 1200 according to embodiments of the present disclosure. An embodiment of the TCI-DCI with beam indication information and HARQ-ACK feedback 1200 shown in FIG. 12 is for illustration only.

In U.S. application Ser. No. 17/148,517 and as illustrated in FIG. 12, a UE can transmit HARQ-ACK feedback in response to a TCI DCI. In this disclosure, aspects related to the design of DL related DCI format without a DL assignment used for beam indication is provided.

The beam indication information for a UE can include one or more of: (1) DL TCI-state information, wherein the DL TCI-state information can be a single TCI-state for PDSCH and PDCCH or multiple TCI-states, for different physical entities, wherein a physical entity can be a carrier, frequency band, a frequency range, a BWP, a TRP, a base station antenna panel, a UE antenna panel, data/control physical channels and signals, etc. The DL TCI state can be common across some physical entities and distinct across other physical entities. Where “some” can include “all,” “part of,” or “none”; (2) UL TCI-state information, wherein the UL TCI-state information can be a single TCI-state for PUSCH and PUCCH and possibly SRS or multiple TCI-states, for different physical entities, wherein a physical entity can be a carrier, frequency band, a frequency range, a BWP, a TRP, a base station antenna panel, a UE antenna panel, data/control physical channels and signals, etc. The UL TCI state can be common across some physical entities and distinct across other physical entities. Where “some” can include “all,” “part of,” or “none”; (3) Joint TCI-state information, wherein the TCI-state information can be a single TCI-state for UL and DL data and control channels and signals or multiple TCI-states, for different physical entities, wherein a physical entity can be a component carrier, cell (e.g., PCell, SCell), frequency band, a frequency range, a BWP, a TRP, a base station antenna panel, a UE antenna panel, data/control physical channels and signals, UL/DL physical channels and signals etc. The common TCI state can be common across some physical entities and distinct across other physical entities. Where “some” can include “all,” “part of,” or “none”; and (4) SRI for UL, wherein the SRI can be a single SRI for PUSCH and PUCCH and possibly SRS or multiple TCI-states, for different physical entities, wherein a physical entity can be a carrier, frequency band, a frequency range, a BWP, a TRP, a base station antenna panel, a UE antenna panel, data/control physical channel, etc. The SRI can be common across some physical entities and distinct across other physical entities. Where “some” can include “all,” “part of,” or “none.”

In one example A1.1, a channel conveying a beam indication (e.g., a TCI state or a spatial relation indication) reuses a DCI format for scheduling PDSCH (e.g., DCI format 1_0, or DCI format 1_1 or DCI format 1_2), wherein the corresponding DCI format does not include a DL assignment.

In one example A1.1.1, a CRC of a DCI format conveying a beam indication, with no DL assignment, is scrambled with a UE specific RNTI such as C-RNTI or CS-RNTI or MCS-C-RNTI.

In another example A1.1.2, a CRC of a DCI format conveying a beam indication, with no DL assignment, is scrambled with a UE specific RNTI for beam indication. This is a new RNTI that is different from the C-RNTI, CS-RNTI and MCS-C-RNTI. This new RNTI can be referred to as beam indication RNTI (BI-RNTI) or TCI-RNTI.

In another example A1.1.3, a CRC of a DCI format conveying a beam indication, with no DL assignment, is scrambled with a UE group specific RNTI for beam indication. This new RNTI can be referred to as Group Beam Indication RNTI (G-BI-RNTI or BI-G-RNTI) or G-TCI-RNTI or TCI-G-RNTI.

In one example A1.1.4, at least the following fields in a DL-related DCI format for beam indication and without DL assignment are kept in the DCI format for the purpose of the field: (1) identifier for DCI formats; (2) TPC command for scheduled PUCCH; (3) PUCCH resource indicator. For the PUCCH resource conveying HARQ-ACK feedback for a DL-related DCI format conveying a beam indication, with no DL assignment; (4) PDSCH-to-HARQ feedback timing indicator. This field indicates the time duration, in number of slots k, between the end of the PDDCH of a DL-related DCI format for beam indication and without DL assignment and the start of the PUCCH resource conveying the corresponding HARQ-ACK Feedback. For a PDDCH transmission received in slot n, the PUCCH transmission is in slot n+k. Wherein, k=0 is the last slot of the PUCCH transmission that overlaps the PDCCH reception. k is the number of PUCCH slots. In one variant, k is the number of slots for PDCCH. Slot n is the slot of the PDCCH reception and slot n+k is a PDCCH slot that overlaps the PUCCH slot of the PUCCH transmission.

In one example A1.1.5, the downlink assignment index (DAI) field in a DL-related DCI format for beam indication and without DL assignment is kept for the determination of the counter DAI and the total DAI to assist in the generation of the HARQ-ACK codebook.

In one example A1.1.6, the carrier indicator and/or bandwidth part indicator fields in a DL-related DCI format for beam indication and without DL assignment is kept for the determination of the corresponding carrier and/or bandwidth part.

In one example A1.1.6a, the time domain resource assignment (TDRA) field in a DL-related DCI format for beam indication and without DL assignment is kept for the determination of bk0 and/or the start length indicator value (SLIC) for determination of the location of the ACK information within the Type-1 HARQ-ACK codebook (e.g., for determination of a virtual PDSCH). Wherein, k0 is the slot offset between the PDCCH slot containing the DCI format and the slot containing a virtual PDSCH, and the SLIV determines the starting symbol of the virtual PDSCH and the length in symbols of the virtual PDSCH. In one example, TDRA determines a row index within a time domain allocation list, wherein the time domain allocation list is configured by higher layer signaling and/or a default time domain allocation list specified in the system specifications.

In one example A1.1.7, some bits or fields of the DCI format are set to a pre-defined value that indicates the DCI format is for beam indication without DL assignment or UL grant. For example, for DCI format 1_1 or DCI format 1_2, one or more of the following bit patterns can be set: (1) the frequency domain resource assignment field can be set to: (i) all 0's for resource Allocation Type 0, (ii) all 1's for resource Allocation Type 1, and/or (iii) in one example, all 1's or all 0's in case of resource allocation of type dynamic switch. In another example all 0's in case of resource allocation of type dynamic switch; (2) redundancy version (RV) field can be set to special pattern e.g., all “1,” all “0” or some special I/O pattern; (3) modulation and coding scheme (MCS) field can be set to special pattern e.g., all “1,” all “0” or some special I/O pattern; (4) HARQ process number (HPN) field can be set to special pattern e.g., all “1,” all “0” or some special I/O pattern; (5) new data indicator (NDI) field can be set to special pattern e.g., “1” or “0”; (6) antenna ports field can be set to special pattern e.g., all “1,” all “0” or some special I/O pattern; and/or (7) DMRS sequence initialization field can be set to special pattern e.g., all “1,” all “0” or some special 1/0 pattern.

In one example, the above fields can be set to a special pattern in such a way that if the C-RNTI and/or MCS-C-RNTI is used to scramble the CRC of the DL-related DCI format for beam indication and without DL assignment the bit pattern for DL-related DCI format for beam indication without DL assignment and that of a DL-related DCI format for SCell dormancy is unique to distinguish the two.

In another example, the above fields can be set to a special pattern in such a way that if the CS-RNTI is used to scramble the CRC of the DL-related DCI format for beam indication and without DL assignment the bit pattern for DL-related DCI format for beam indication without DL assignment and that of SPS release is each unique to distinguish the two. The special pattern is also unique to distinguish DL-related DCI format, scrambled with CS-RNTI, for beam indication and without DL assignment from a DCI format with CRC scrambled by CS-RNTI and used for SPS activation or re-transmission of DL-SPS.

In one example, the special pattern for a DL-related DCI format for beam indication and without DL assignment can be set as shown in TABLE 4 to TABLE 10. The CRC is scrambled with the CS-RNTI.

TABLE 4
Special pattern for DCI format with beam
indication and without a DL assignment

| | DCI format for beam | |
|---|---|---|
| | indication with No DL | DCI format for |
| | assignment | SPS release |
| Frequency domain | Same as SPS release | set to all “0”s for FDRA |
| resource | | Type 0 or for |
| assignment (FDRA) | | dynamic Switch |
| | | set to all “1”s for FDRA |
| | | Type 1 |
| Redundancy | RV is set to all “1”s | RV is set to all “0”s |
| version (RV) | (e.g., ‘11’) | |
| Modulation and coding | MCS is set to all “1”s | MCS is set to all “1”s |
| scheme (MCS) | (e.g., ‘111’) | |
| New data | NDI is set to one | NDI is set to “0” |
| indicator (NDI) | of the following: | |
| | “0” | |
| | “1” | |
| | Not used (e.g., no | |
| | special setting) | |
| HARQ process | HPN is set to one | HPN is set to all “0”s |
| number (HPN) | of the following: | |
| | All “0”s | |
| | A value configured | |
| | by RRC. | |
| | Not used (e.g., no | |
| | special setting) | |

TABLE 5
Special pattern for DCI format with beam
indication and without a DL assignment

| | DCI format for beam | |
|---|---|---|
| | indication with No DL | DCI format for |
| | assignment | SPS release |
| Frequency domain | Same as SPS release | set to all “0”s for FDRA |
| resource | | Type 0 or for |
| assignment (FDRA) | | dynamicSwitch |
| | | set to all “1”s for FDRA |
| | | Type 1 |
| Redundancy | RV is set to all “1”s | RV is set to all “0”s |
| version (RV) | | |
| New data | NDI is set to one | NDI is set to “0” |
| indicator (NDI) | of the following: | |
| | “0” | |
| | “1” | |
| | Not used (e.g., no | |
| | special setting) | |
| HARQ process | HPN is set to one | HPN is set to all “0”s |
| number (HPN) | of the following: | |
| | All “0”s | |
| | A value configured | |
| | by RRC. | |
| | Not used (e.g., no | |
| | special setting) | |

TABLE 6
Special pattern for DCI format with beam
indication and without a DL assignment

| | DCI format for beam | |
|---|---|---|
| | indication with No DL | DCI format for |
| | assignment | SPS release |
| Frequency domain | Same as SPS release | set to all “0”s for FDRA |
| resource | | Type 0 or for |
| assignment (FDRA) | | dynamicSwitch |
| | | set to all “1”s for FDRA |
| | | Type 1 |
| Modulation and coding | MCS is set to all “1”s | MCS is set to all “1”s |
| scheme (MCS) | | |
| New data | NDI is set to one | NDI is set to “0” |
| indicator (NDI) | of the following: | |
| | “0” | |
| | “1” | |
| | Not used (e.g., no | |
| | special setting) | |
| HARQ process | HPN is set to one | HPN is set to all “0”s |
| number (HPN) | of the following: | |
| | All “0”s | |
| | A value configured | |
| | by RRC. | |
| | Not used (e.g., no | |
| | special setting) | |

TABLE 7
Special pattern for DCI format with beam
indication and without a DL assignment

| | DCI format for beam | |
|---|---|---|
| | indication with No DL | DCI format for |
| | assignment | SPS release |
| Redundancy | RV is set to all “1”s | RV is set to all “0”s |
| version (RV) | | |
| Modulation and coding | MCS is set to all “1”s | MCS is set to all “1”s |
| Scheme (MCS) | | |
| New data | NDI is set to one | NDI is set to “0” |
| indicator (NDI) | of the following: | |
| | “0” | |
| | “1” | |
| | Not used (e.g., no | |
| | special setting) | |
| HARQ process | HPN is set to one | HPN is set to all “0”s |
| number (HPN) | of the following: | |
| | All “0”s | |
| | A value configured | |
| | by RRC. | |
| | Not used (e.g., no | |
| | special setting) | |

TABLE 8
Special pattern for DCI format with beam
indication and without a DL assignment

| | DCI format for beam | |
|---|---|---|
| | indication with No DL | DCI format for |
| | assignment | SPS release |
| Frequency domain | Same as SPS release | set to all “0”s for FDRA |
| resource | | Type 0 or for |
| assignment (FDRA) | | dynamicSwitch |
| | | set to all “1”s for FDRA |
| | | Type 1 |
| New data | NDI is set to one | NDI is set to “0” |
| indicator (NDI) | of the following: | |
| | “0” | |
| | “1” | |
| | Not used (e.g., no | |
| | special setting) | |
| HARQ process | HPN is set to one | HPN is set to all “0”s |
| number (HPN) | of the following: | |
| | All “0”s | |
| | A value configured | |
| | by RRC. | |
| | Not used (e.g., no | |
| | special setting) | |

TABLE 9
Special pattern for DCI format with beam
indication and without a DL assignment

| | DCI format for beam | |
|---|---|---|
| | indication with No DL | DCI format for |
| | assignment | SPS release |
| Redundancy | RV is set to all “1”s | RV is set to all “0”s |
| version (RV) | | |
| New data | NDI is set to one | NDI is set to “0” |
| indicator (NDI) | of the following: | |
| | “0” | |
| | “1” | |
| | Not used (e.g., no | |
| | special setting) | |
| HARQ process | HPN is set to one | HPN is set to all “0”s |
| number (HPN) | of the following: | |
| | All “0”s | |
| | A value configured | |
| | by RRC. | |
| | Not used (e.g., no | |
| | special setting) | |

TABLE 10
Special pattern for DCI format with beam
indication and without a DL assignment

| | DCI format for beam | |
|---|---|---|
| | indication with No DL | DCI format for |
| | assignment | SPS release |
| Modulation and coding | MCS is set to all “1”s | MCS is set to all “1”s |
| scheme (MCS) | | |
| New data | NDI is set to one | NDI is set to “0” |
| indicator (NDI) | of the following: | |
| | “0” | |
| | “1” | |
| | Not used (e.g., no | |
| | special setting) | |
| HARQ process | HPN is set to one | HPN is set to all “0”s |
| number (HPN) | of the following: | |
| | All “0”s | |
| | A value configured | |
| | by RRC. | |
| | Not used (e.g., no | |
| | special setting) | |

In another example, the above fields can be set to a special pattern for any RNTI that scrambles the CRC of the DL-related DCI format for beam indication and without DL assignment, including a beam indication RNTI (e.g., BI-RNTI) or a TCI-RNTI. TABLE 11 and TABLE 12 are examples for setting this special pattern.

TABLE 11
One example of special pattern setting for a DL-Related
DCI format for beam indication without DL assignment

| | DCI format 1_0/1_1/1_2 |
|---|---|
| HARQ process number | set to all “0”s |
| Redundancy version | set to all “0”s |
| Modulation and coding | set to all “1”s |
| scheme | |
| Frequency domain | set to all “0”s for FDRA |
| resource assignment | Type 0 or for |
| | dynamicSwitch |
| | set to all “1”s for FDRA |
| | Type 1 |

TABLE 12
Another example of special pattern setting for a DL-Related
DCI format for beam indication without DL assignment

| | DCI format 1_0/1_1/1_2 |
|---|---|
| Redundancy version | set to all “0”s |
| Modulation and | set to all “1”s |
| coding scheme | |
| Frequency domain | set to all “0”s for FDRA |
| resource assignment | Type 0 or for |
| | dynamicSwitch |
| | set to all “1”s for FDRA |
| | Type 1 |

In one example A1.1.8, the remaining bits or fields of the DCI format that are not used, as described in example A1.1.4, example A1.1.5, example A1.1.6 and example A1.1.7, can be repurposed for TCI state indication, for example to indicate one or more of: (1) DL TCI states; (2) UL TCI states; (3) joint UL/DL TCI states; or (4) separate DL TCI States and UL TCI states.

After indication of the one or more TCI states, if there are remaining bits or fields in the DCI format, these bits can be one of: (1) reserve, for example for future use; (2) set to pre-defined values; or (3) a combination of some bits reserved and some bits set to pre-defined values.

FIG. 13 illustrates an example of components of DCI format 1300 according to embodiments of the present disclosure. An embodiment of the components of DCI format 1300 shown in FIG. 13 is for illustration only.

FIG. 13 is an example of the components of DCI format (e.g., DCI format 1_0, 1_1 or 1_2) for conveying a beam indication with no DL assignment. The components of the DCI format can include: (1) fields that retain their purpose (example A1.1.4, example A1.1.5 and example A1.1.6); (2) zero, one or more fields or bits with a special value that indicate a DCI format for beam indication with no DL assignment or UL grant. in one example, if the RNTI that scrambles the CRC is unique for beam indication (i.e., different from CS-RNTI, C-RNTI and MCS-C-RNTI), this component can be absent, i.e., it has zero bit. Alternatively, this component can be present regardless of the RNTI used; (3) one or more beam indicators (e.g., TCI states or spatial relation indications); (4) remaining fields or bits are reserved and/or set to pre-defined values; and (5) CRC with some or all bits scrambled with a UE-specific or UE-group RNTI. In one example, the UE specific RNTI can be CS-RNTI, C-RNTI or MCS-C-RNTI. In another example, the UE specific RNTI can be an RNTI for beam indication that different from CS-RNTI, C-RNTI or MCS-C-RNTI. In another example, the UE group RNTI can be an RNTI for beam indication.

In one example A1.1.9, a field is added to the DCI format, the field indicates if the DCI format indicates one or more TCI states without DL assignment or UL grant, or if the DCI format is used for scheduling PDSCH or PUSCH or other usage as described in the specifications (e.g., SPS release, SCell Dormancy). If the field indicates a beam indication (e.g., a TCI state or a spatial relation indication) is being conveyed in the DCI format without a DL assignment, the remaining bits or fields (not used for their purpose as described in example A1.1.4, example A1.1.5 and example A1.1.6) of the DCI format can be repurposed for TCI state indication, for example to indicate one or more of: (1) DL TCI states; (2) UL TCI states; (3) joint UL/DL TCI states; or separate DL TCI states and UL TCI states.

After indication of the one or more TCI states, if there are remaining bits or fields in the DCI format, these bits can be one of: (1) reserve, for example for future use; (2) set to pre-defined values; or (3) a combination of some bits reserved and some bits set to pre-defined values.

FIG. 14 illustrates another example of components of DCI format 1400 according to embodiments of the present disclosure. An embodiment of the components of DCI format 1400 shown in FIG. 14 is for illustration only.

FIG. 14 is an example of the components of DCI format (e.g., DCI format 1_0, 1_1 or 1_2) for conveying a beam indication with no DL assignment. The components of the DCI format can include: (1) fields that retain their purpose (example A1.1.4, example A1.1.5 and example A1.1.6); (2) a flag (if any) that indicates a DCI format for beam indication without DL assignment or UL grant: (i) if flag does not indicate a DCI format for beam indication without DL assignment or UL grant, the remaining fields or bits are as defined for the corresponding DCI format. Otherwise, the DCI format is for beam indication without DL assignment or UL grant and the remaining fields or bits can be defined as described below, and (ii) in one example, if the RNTI that scrambles the CRC is unique for beam indication (i.e., different from CS-RNTI, C-RNTI and MCS-C-RNTI), this component can be absent, i.e., it has zero bit, (iii) alternatively, this component can be present regardless of the RNTI used; (3) one or more beam indicators (e.g., TCI states or spatial relation indications); (4) remaining fields or bits are reserved and/or set to pre-defined values; and (5) CRC with some or all bits scrambled with a UE-specific or UE-group RNTI: (i) in one example, the UE specific RNTI can be CS-RNTI, C-RNTI or MCS-C-RNTI; (ii) in another example, the UE specific RNTI can be an RNTI for beam indication that different from CS-RNTI, C-RNTI or MCS-C-RNTI; and (iii) in another example, the UE group RNTI can be an RNTI for beam indication.

In one example A1.1.10, a DL-related DCI format for beam indication and without DL assignment indicates one or more TCI state IDs as described in example A1.1.8 and example A1.1.9 (e.g., using the ‘Transmission Configuration Indication’ field). In one example, as described earlier, the presence of the ‘Transmission Configuration Indication’ filed is configured by higher layer parameter tci-PresentInDCI. In another example, the ‘Transmission Configuration Indication’ filed is always present. In yet another example, the ‘Transmission Configuration Indication’ filed is present if more than one TCI state ID (or TCI state codepoint) is activated.

In one example A1.1.10.1, one TCI state ID (or TCI state codepoint) can be indicated in the DCI format (e.g., using the ‘Transmission Configuration Indication’ field), wherein the TCI state ID can be a TCI state ID (or TCI state codepoint) for one of the following types: (1) DL TCI state; (2) UL TCI state; (3) joint TCI state (for DL and UL); or (4) separate TCI state (a TCI state ID that indicate a DL TCI state and separate UL TCI).

The indicated TCI state IDs (or TCI state codepoints) can be one of: (1) TCI state IDs configured by RRC or (2) TCI state IDs activated by MAC CE.

The type of TCI state ID (or TCI state codepoint) indicated in the DCI format can be determined based on one or more of the following: (1) a flag is included in the DCI format to indicate the type of TCI state ID; (2) each TCI state ID corresponds to a unique TCI state ID type, and there is no additional signaling to determine the TCI state ID type; (3) a unique RNTI is used for each TCI state ID type; or (4) MAC CE signaling and/or RRC configuration for TCI state ID type in the DCI format. In one example, the TCI state ID can be for a joint TCI state or for separate TCI states. MAC CE and/or RRC signaling can indicate if the TCI state ID included in the DCI format is for joint TCI state or for separate TCI states.

In another example A1.1.10.2, one or more TCI state IDs can be indicated in the DCI format, wherein the TCI state IDs can be a TCI state IDs for one of the following types: (1) DL TCI state; (2) UL TCI state; (3) joint TCI state (for DL and UL); or (4) separate TCI state (a TCI state ID that indicate a DL TCI state and separate UL TCI).

The indicated TCI state IDs can be one of: (1) TCI state IDs configured by RRC; or (2) TCI state IDs activated by MAC CE.

The number of TCI state IDs and the type of TCI state ID indicated in the DCI format can be determined based on one or more of the following: (1) a flag/field is included in the DCI format to indicate the type of TCI state IDs and the number of TCI state IDs; (2) each TCI state ID corresponds to a unique TCI state ID type, and there is no additional signaling to determine the TCI state ID type. A field for the number of TCI state IDs in the DCI format can be included in the DCI format; (3) a unique RNTI is used for each TCI state ID types/number combination that is configure; or (4) MAC CE signaling and/or RRC configuration for TCI state ID types and/or number of TCI state IDs in the DCI format. In one example, the M TCI state IDs can be signaled for a joint TCI state or for separate TCI states. MAC CE and/or RRC signaling can indicate the number of M TCI state IDs as well as the type of each of the M TCI state IDs included in the DCI format.

In one example A2.1, a UE can transmit HARQ-ACK feedback (e.g., on PUCCH or on PUSCH if PUCCH overlaps a PUSCH) in response to a DCI format conveying a beam indication (e.g., a TCI state or a spatial relation indication) without a DL assignment.

In one example A2.1.1, a first may be PUCCH transmission for HARQ-ACK feedback of a DCI format conveying beam indication without a DL assignment overlaps a second may be PUCCH transmission with UCI. The HARQ-ACK feedback of the first may be PUCCH transmission is multiplexed with the UCI of the second may be PUCCH transmission and is transmitted on a third PUCCH transmission.

In another example A2.1.2, a would-be PUCCH transmission for HARQ-ACK feedback of a DCI format conveying beam indication without a DL assignment overlaps a PUSCH transmission. The HARQ-ACK feedback of the would-be PUCCH transmission is multiplexed and transmitted on the PUSCH transmission.

In another example A2.2, if a would-be PUCCH transmission for HARQ-ACK feedback of a DCI format conveying beam indication without a DL assignment overlaps a would-be UL transmission (e.g., a PUCCH and/or PUSCH and/or SRS), the would-be UL transmission is dropped and the PUCCH transmission for HARQ-ACK feedback of a DCI format conveying beam indication without a DL assignment is transmitted.

In one example A2.2.1, a higher layer parameter can be configured by RRC configuration and/or MAC CE signaling to determine whether to: (1) drop an UL transmission that overlaps (e.g., partially or fully) with a HARQ-ACK feedback of a DCI format conveying beam indication without a DL assignment or (2) multiplex the HARQ-ACK feedback with the UL transmission.

In one example A2.2.2, a higher layer parameter can be configured by RRC configuration and/or MAC CE signaling to determine whether to: (1) drop a PUCCH transmission that overlaps (e.g., partially or fully) with a HARQ-ACK feedback of a DCI format conveying beam indication without a DL assignment or (2) multiplex the HARQ-ACK feedback with the PUCCH transmission.

In one example A2.2.3, a higher layer parameter can be configured by RRC configuration and/or MAC CE signaling to determine whether to: (1) drop a PUSCH transmission that overlaps (e.g., partially or fully) with a HARQ-ACK feedback of a DCI format conveying beam indication without a DL assignment or (2) multiplex the HARQ-ACK feedback with the PUSCH transmission.

In another example A2.2a, if a would-be first PUCCH transmission for HARQ-ACK feedback of a DCI format conveying beam indication without a DL assignment overlaps a would be second PUCCH transmission, the would-be second PUCCH transmission is dropped and the first PUCCH transmission for HARQ-ACK feedback of a DCI format conveying beam indication without a DL assignment is transmitted.

In one example A2.2a.1, a higher layer parameter can be configured by RRC configuration and/or MAC CE signaling to determine whether to: (1) drop the second PUCCH transmission that overlaps (e.g., partially or fully) with a HARQ-ACK feedback of a DCI format conveying beam indication without a DL assignment or (2) multiplex the HARQ-ACK feedback with the second PUCCH transmission.

In another example A2.2b, if a would-be first PUCCH transmission for HARQ-ACK feedback of a DCI format conveying beam indication without a DL assignment overlaps a would-be second PUCCH transmission conveying HARQ-ACK information that does not include HARQ-ACK feedback of a DCI format conveying beam indication without a DL assignment, the would-be second PUCCH transmission is dropped and the first PUCCH transmission for HARQ-ACK feedback of a DCI format conveying beam indication without a DL assignment is transmitted.

In one example A2.2b.1, a higher layer parameter can be configured by RRC configuration and/or MAC CE signaling to determine whether to: (1) drop the second PUCCH transmission that overlaps (e.g., partially or fully) with a HARQ-ACK feedback of a DCI format conveying beam indication without a DL assignment or (2) multiplex the HARQ-ACK feedback of a DCI format conveying beam indication without a DL assignment with the second PUCCH transmission.

In another example A2.2c, if a would-be PUCCH transmission for HARQ-ACK feedback of a DCI format conveying beam indication without a DL assignment overlaps a would-be PUSCH transmission without UL-SCH, the would-be PUSCH transmission is dropped and the PUCCH transmission for HARQ-ACK feedback of a DCI format conveying beam indication without a DL assignment is transmitted.

In one example A2.2c.1, a higher layer parameter can be configured by RRC configuration and/or MAC CE signaling to determine whether to: (1) drop the PUSCH transmission, without UL-SCH, that overlaps (e.g., partially or fully) with a HARQ-ACK feedback of a DCI format conveying beam indication without a DL assignment or (2) multiplex the HARQ-ACK feedback with the PUSCH transmission.

In another example A2.2d, if a would-be PUCCH transmission for HARQ-ACK feedback of a DCI format conveying beam indication without a DL assignment overlaps a would-be PUSCH transmission multiplexing UCI and UL-SCH, the would-be PUSCH transmission is dropped and the PUCCH transmission for HARQ-ACK feedback of a DCI format conveying beam indication without a DL assignment is transmitted.

In one example A2.2d.1, a higher layer parameter can be configured by RRC configuration and/or MAC CE signaling to determine whether to: (1) drop the PUSCH transmission, multiplexing UCI and UL-SCH, that overlaps (e.g., partially or fully) with a HARQ-ACK feedback of a DCI format conveying beam indication without a DL assignment or (2) multiplex the HARQ-ACK feedback with the PUSCH transmission.

In one example A2.3, a UE can transmit HARQ-ACK feedback in response to a DCI format conveying a beam indication (e.g., a TCI state or a spatial relation indication) without a DL assignment in an uplink channel (e.g., PUCCH or PUSCH) that starts at least after N symbols from the end of the PDCCH that includes a DCI format conveying a beam indication (e.g., a TCI state or a spatial relation indication) without a DL assignment.

In one example A2.3.1, N depends on a UE capability.

In another example A2.3.2, N (as a value and as a time unit) depends on a sub-carrier spacing. Wherein, the sub-carrier spacing can be one of the following: (1) the sub-carrier spacing of the PUCCH reception; (2) the sub-carrier spacing of the PDCCH transmission; (3) the smallest sub-carrier spacing of the PUCCH reception and the sub-carrier spacing of the PDCCH transmission; or (4) the largest sub-carrier spacing of the PUCCH reception and the sub-carrier spacing of the PDCCH transmission.

In another example A2.3.3, N depends on a combination of UE capability and sub-carrier spacing (as described in example 2.3.2). TABLE 13 is an example of N for two different UE capabilities and different sub-carrier spacings. In this example, UE capability 1 does not support sub-carrier spacing 120 kHz.

TABLE 13
Minimum number of symbols N between end of PDCCH
with a DCI format for Beam indication and without
DL assignment and start of Corresponding PUCCH

| Sub-carrier Spacing | UE Capability 1 | UL Capability 2 |
|---|---|---|
| 15 kHz (μ = 0) | 5 | 10 |
| 30 kHz (μ = 1) | 5.5 | 12 |
| 60 kHz (μ = 2) | 11 | 22 |
| 120 kHz (μ = 3) | N/A | 25 |

In one example A2.4, a UE can transmit HARQ-ACK feedback in response to a DCI format conveying a beam indication (e.g., a TCI state or a spatial relation indication) without a DL assignment in an uplink channel (e.g., PUCCH or PUSCH). For a PDCCH transmission in slot n containing a DCI format conveying a beam indication (e.g., a TCI state or a spatial relation indication), the corresponding may be PUCCH transmission for the HARQ-ACK feedback is in slot n+k. Wherein, k is determined by one of the following: (1) field “PDSCH-to-HARQ feedback timing indicator” (or a field providing a similar purpose) in the DCI format; and (2) if field “PDSCH-to-HARQ feedback timing indicator” is not present the DCI format, higher layer parameters dl-DataToUL-ACK, or dl-DataToUL-ACKForDCIFormat1_2 for DCI format 1_2 (or a parameter providing a similar purpose).

In one example A2.4.1, k is the number of PUCCH slots (i.e., using PUCCH numerology), k=0 is the last slot of the PUCCH transmission that overlaps the PDCCH reception.

In one example A2.4.1a, k is the number of PUCCH symbols (i.e., using PUCCH numerology).

In another example A2.4.2, k is the number of slots for PDCCH (i.e., using PDCCH numerology). Slot n is the slot of the PDCCH reception and slot n+k is a PDCCH slot that overlaps the PUCCH slot of the PUCCH transmission.

In one example A2.4.2a, k is the number of PDCCH symbols (i.e., using PDCCH numerology).

In one example A2.4.3, if the UE reports HARQ-ACK information for the beam indication DCI format in a slot other than slot n+k, the UE sets a value for each corresponding HARQ-ACK information bit to NACK.

In one example A2.5, a UE can transmit HARQ-ACK feedback in response to a DL-related DCI format conveying a beam indication (e.g., a TCI state or a spatial relation indication) without a DL assignment in an uplink channel (e.g., PUCCH or PUSCH). In one example, a virtual PDSCH transmission is assumed in the same slot as the slot of the PDCCH transmission. In one example, the virtual PDSCH, in the same slot of the PDCCH, can be based on the SLIV indicated in the TDRA field of the DCI format, wherein the SLIV determines the starting symbol of the virtual PDSCH and the length in symbols of the virtual PDSCH. In another example, the virtual PDSCH is based on TDRA field of the DCI format, wherein the TDRA determines k0, i.e., the slot offset between the PDCCH slot and virtual PDSCH slot, and SLIV of the virtual PDSCH. For the virtual PUCCH transmission in slot n, the corresponding may be PUCCH transmission for the HARQ-ACK feedback is in slot n+k.

Wherein, k is determined by one of the following: (1) in one example A2.5.1, k is the number of PUCCH slots, k=0 is the last slot of the PUCCH transmission that overlaps the virtual PDSCH reception; (2) in another example A2.5.2, k is the number of slots for PDSCH. Slot n is the slot of the virtual PDSCH reception and slot n+k is a PDCCH slot that overlaps the PUCCH slot of the PUCCH transmission.

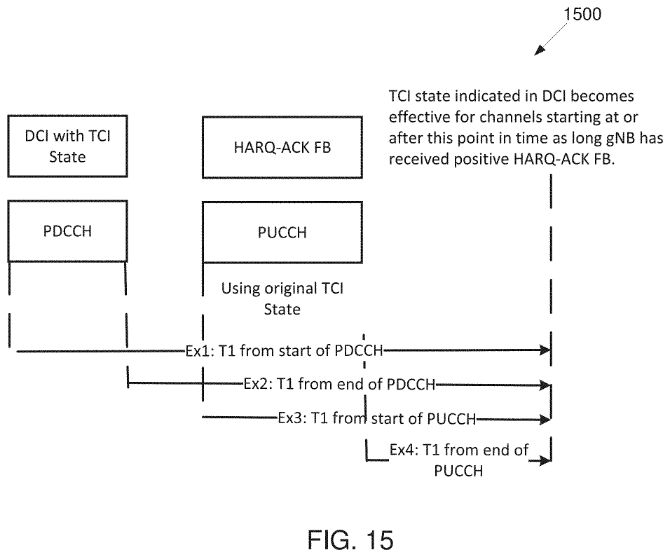

In another example A2.6, a DL related DCI format conveying a beam indication (e.g., a TCI state or a spatial relation indication) without a DL assignment has a HARQ-ACK feedback. The HARQ-ACK feedback is positive if the DCI is successfully received, if the DCI is not received there is no HARQ-ACK feedback (DTX in this case). In the HARQ-ACK codebook a DTX for HARQ-ACK can correspond to a NACK. The UE can apply the beam after a delay T₁ (e.g., timeDurationForQCL) from the HARQ-ACK feedback associated with a DCI transmission with the DL-Related DCI as shown in FIG. 15.

FIG. 15 illustrates an example of a beam based on the HARQ-ACK feedback associated with a DCI transmission with the DL-Related DCI 1500 according to embodiments of the present disclosure. An embodiment of the beam based on the HARQ-ACK feedback associated with a DCI transmission with the DL-Related DCI 1500 shown in FIG. 15 is for illustration only.

In one example A2.6.1, the time duration T₁ is from the start of the PDCCH carrying the DL-related DCI format with TCI state indication (beam indication) and without DL assignment (cf. U.S. patent application Ser. No. 17/444,556, filed Aug. 5, 2021, which is incorporated by reference in its entirety). In one example, the start of the PDCCH corresponds to the beginning time of the first OFDM symbol that carries the PDCCH.

In another example A2.6.2, the time duration T₁ is from the end of the PDCCH carrying the DL-related DCI with TCI state indication (beam indication) and without DL assignment (cf. U.S. patent application Ser. No. 17/444,556). In one example, the end of the PDCCH corresponds to the ending time of the last OFDM symbol that carries the PDCCH.

In another example A2.6.3, the time duration T₁ is from the start of the PUCCH carrying the corresponding HARQ-ACK feedback (cf. U.S. patent application Ser. No. 17/444,556). In one example, the start of the PUCCH corresponds to the beginning time of the first OFDM symbol that carries the PUCCH.

In another example A2.6.4, the time duration T₁ is from the end of the PUCCH carrying the corresponding HARQ-ACK feedback (cf. U.S. patent application Ser. No. 17/444,556). In one example, the end of the PUCCH corresponds to the ending time of the last OFDM symbol that carries the PUCCH.

In one example A2.6.5, a gNB and a UE continue to use the original beam if gNB does not receive and the UE does not transmit positive HARQ-ACK acknowledgement for the PDCCH transmission with the DL-related DCI with TCI state indication.

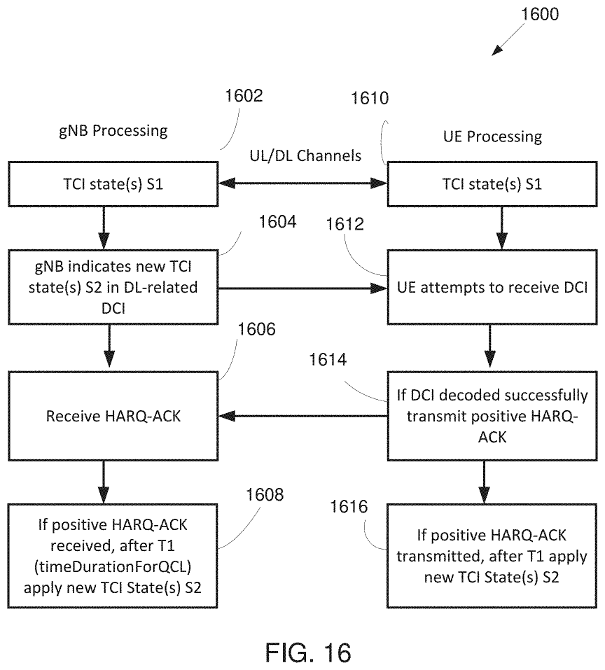

FIG. 16 illustrates an example of a gNB and UE procedure 1600 according to embodiments of the present disclosure. The gNB and UE procedure 1600 1000 as may be performed by a UE (e.g., 111-116 as illustrated in FIG. 1) and a BS (e.g., 101-103 as illustrated in FIG. 1). An embodiment of the gNB and UE procedure 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

As illustrated in FIG. 16, in step 1602, a gNB processes TCI state(s) S1. In step 1604, the gNB indicates new TCI state(s) S2 in DL-related DCI. In step 1606, the gNB receives HARA-ACK from a UE. In step 1608, the gNB determines whether a positive HARQ-ACK is received after applying T1 (timeDurationForQCL) to new TCI State(s) S2. In step 1610, a UE processes the TCI state(s) S1. In step 1612, the UE attempts receive DCI. In step 1614, the UE determines whether DCI is decoded successfully and then transmits positive HARQ-ACK to the gNB. In step 1616, the UE determines whether a positive HARQ-ACK is transmitted after applying T1 apply to new TCI State(s) S2.

In another example A2.6.6, the UE can apply the beam indicated by the TCI state to UL transmission containing the HARQ-ACK feedback of the DL related DCI format conveying a beam indication (e.g., a TCI state or a spatial relation indication) without a DL assignment.

In one example A2.6.6.1, if the time duration between the end of the PDDCH of the DCI format and the start of the would-be PUCCH transmission with the corresponding HARQ-ACK feedback is less than (or less than or equal) T₁ (e.g., timeDurationForQCL), the original beam (not the one indicated) is applied to the UL transmission (e.g., PUCCH or PUSCH) containing the HARQ-ACK feedback. If the time duration between the end of the PDDCH of the DCI format and the start of the would-be PUCCH transmission with the corresponding HARQ-ACK feedback is greater than or equal (or greater than) T₁ (e.g., timeDurationForQCL), the indicated beam is applied to the UL transmission (e.g., PUCCH or PUSCH) containing the HARQ-ACK feedback.

In one example A2.6.6.2, if the time duration between the end of the PDDCH of the DCI format and the start of the UL transmission (e.g., PUCCH or PUSCH) with the corresponding HARQ-ACK feedback is less than (or less than or equal) T₁ (e.g., timeDurationForQCL), the original beam (not the one indicated) is applied to the UL transmission (e.g., PUCCH or PUSCH) containing the HARQ-ACK feedback. If the time duration between the end of the PDDCH of the DCI format and the start of the UL transmission (e.g., PUCCH or PUSCH) with the corresponding HARQ-ACK feedback is greater than or equal (or greater than) T₁ (e.g., timeDurationForQCL), the indicated beam is applied to the UL transmission (e.g., PUCCH or PUSCH) containing the HARQ-ACK feedback.

In one example A2.6.6.3, the indicated beam is applied to the UL transmission (e.g., PUCCH or PUSCH) containing the HARQ-ACK feedback.

In the above examples, the delay T₁ (e.g., timeDurationForQCL) can be specified in the system specifications and/or configured or updated by RRC signaling and/or MAC CE signaling and/or L1 control signaling. The delay T₁ (e.g., timeDurationForQCL) can further depend on a UE capability. Furthermore,

In one example A2.6.7, the UE capability defines the earliest switching time from the time of arrival of a PDCCH (start or end) with a DL-related DCI with beam indication and without DL assignment. The network signals through RRC and/or MAC CE and/or L1 control signaling one or more beam switching time(s). Wherein, the beam switching time can be measured from: (1) in one example A3.4.1, the PDCCH (start or end) with the DL-related DCI; or (2) in another example A3.4.2, the HARQ-ACK feedback (start or end) associated with the DCI format conveying the beam indication.

The network can ensure that the beam switching time signaled may occur no earlier than the time indicated by the UE capability, otherwise it may be an error case, or it may be up to the implementation of the UE when the beam switching according to the TCI state indicated in the DL related DCI takes effect.

In another example A2.7, a DL related DCI format conveying a beam indication (e.g., a TCI state or a spatial relation indication) without a DL assignment has a HARQ-ACK feedback. The HARQ-ACK feedback is positive if the DCI is successfully received, if the DCI is not received there is no HARQ-ACK feedback (DTX in this case). In the HARQ-ACK codebook a DTX for HARQ-ACK can correspond to a NACK.

In one example A2.7.1, the HARQ-ACK codebook can be Type-1 HARQ-ACK codebook (semi-static codebook). A UE reports HARQ-ACK information for a corresponding DCI format conveying beam indication only in a HARQ-ACK codebook that the UE transmits in a slot indicated by a value of a PDSCH-to-HARQ_feedback timing indicator field in a corresponding DCI format. The UE reports NACK value(s) for HARQ-ACK information bit(s) in a HARQ-ACK codebook that the UE transmits in a slot not indicated by a value of a PDSCH-to-HARQ_feedback timing indicator field in a corresponding DCI format. The HARQ-ACK codebook can also include HARQ-ACK information for a corresponding PDSCH reception or SPS PDSCH release.

In one example A2.7.1.1, the location of the ACK information within the Type-1 HARQ-ACK codebook is determined based on a virtual PDSCH, wherein the virtual PDSCH, is in the same slot of the PDCCH, and is determined by the SLIV indicated in the TDRA field of the DCI format, wherein the SLIV determines the starting symbol of the virtual PDSCH and the length in symbols of the virtual PDSCH.

In one example, the TDRA field selects a row in a time domain allocation list configured or specified for a dynamic PDSCH.

In another example, the TDRA field selects a row in a time domain allocation list configured or specified for the beam indication DCI format.

In one example A2.7.1.2, the location of the HARQ-ACK information within the Type-1 HARQ-ACK codebook is determined based on a virtual PDSCH, wherein the virtual PDSCH is based on (i.e., determined by) TDRA field of the DCI format, wherein the TDRA determines k0, i.e., the slot offset between the PDCCH slot and virtual PDSCH slot, and SLIV of the virtual PDSCH.

In one example, the TDRA field selects (i.e., determines) a row in a time domain allocation list configured or specified for a dynamic PDSCH.

In another example, the TDRA field selects (i.e., determines) a row in a time domain allocation list configured or specified for the beam indication DCI format.

In one example A2.7.1.3, the location of the ACK information within the Type-1 HARQ-ACK codebook is determined based on a virtual PDSCH, wherein the virtual PDSCH is based on: (1) a specific (e.g., reference) k0 value (e.g., k0=0). Wherein, k0 can be specified in the system specifications and/or configured and/or updated by RRC signaling and/or MAC CE signaling and/or L1 control signaling. In one example, k0 is indicated in the DCI format and/or (2) (2) a specific (e.g., reference) SLIV value. Wherein, SLIV can be specified in the system specifications and/or configured and/or updated by RRC signaling and/or MAC CE signaling and/or L1 control signaling. In one example, the SLIV is indicated in the DCI format.

In one example A2.7.1.4, the location of the ACK information within the Type-1 HARQ-ACK codebook can be configured to be determined based on example A2.7.1.1 or example A2.7.1.2 or example A2.7.1.3. Wherein, the configuration can be RRC signaling and/or MAC CE signaling and/or L1 control signaling.

In one example A2.7.1.5, the location of the ACK information within the Type-1 HARQ-ACK codebook can be determined based on a condition to select one of example A2.7.1.1 or example A2.7.1.2 or example A2.7.1.3. Wherein, the condition can be specified in the system specification and/or configured by RRC signaling and/or MAC CE signaling and L1 control signaling.

In one example A2.7.1.6, the location of the HARQ-ACK information bits within the Type-1 HARQ-ACK codebook is determined based on a virtual PDSCH, wherein the virtual PDSCH is determined according to an RRC configured TDRA table and/or a default TDRA table (e.g., a table specified in the system specifications). In one example, the TDRA table is the same as that configured for a dynamic PDSCH. In another example, the TDRA table is a default TDRA table specified in the system specifications. In another example, the TDRA table is signaled by higher layers (e.g., RRC signaling and/or MAC CE signaling) selecting one of TDRA tables specified in the system specifications. In another example, the TDRA table is a new table configured for the beam indication DCI format.

In one example A2.7.1.7, multiple Type-1 HARQ-ACK codebooks are configured, wherein the location of the ACK information within each codebook is determined according to one of example A2.7.1.1 or example A2.7.1.2 or example A2.7.1.3. The codebook to use can be configured by RRC signaling and/or MAC CE signaling and/or L1 control signaling and/or indicated in the DCI format.

In another example A2.7.2, the HARQ-ACK codebook can be Type-2 HARQ-ACK codebook (dynamic codebook).

In one example A2.7.2.1, the location of the HARQ-ACK information within the Type-2 HARQ-ACK codebook is determined following the same rules as that of SPS PDSCH release.

In another example A2.7.3, the HARQ-ACK codebook can be Type-3 HARQ-ACK codebook.

In the present disclosure, a TCI state is used for beam indication. It can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be a gNB or a UE panel specific or common across panels. In some examples, the uplink TCI state can be replaced by SRI or UL source RS.

As described in U.S. patent application Ser. No. 17/148,517, a DL-related DCI is a DCI that carries DL assignment information, such as DCI format 1_1, DCI format 1_2 or DCI format 1_0. A DL-related DCI can include a joint TCI for DL/UL beam indication or a separate TCIs for DL/UL beam indication or a DL TCI for DL beam indication. A DL-related DCI can be DCI format 1_1, DCI format 1_2 or DCI format 1_0 with DL assignment or without DL assignment.

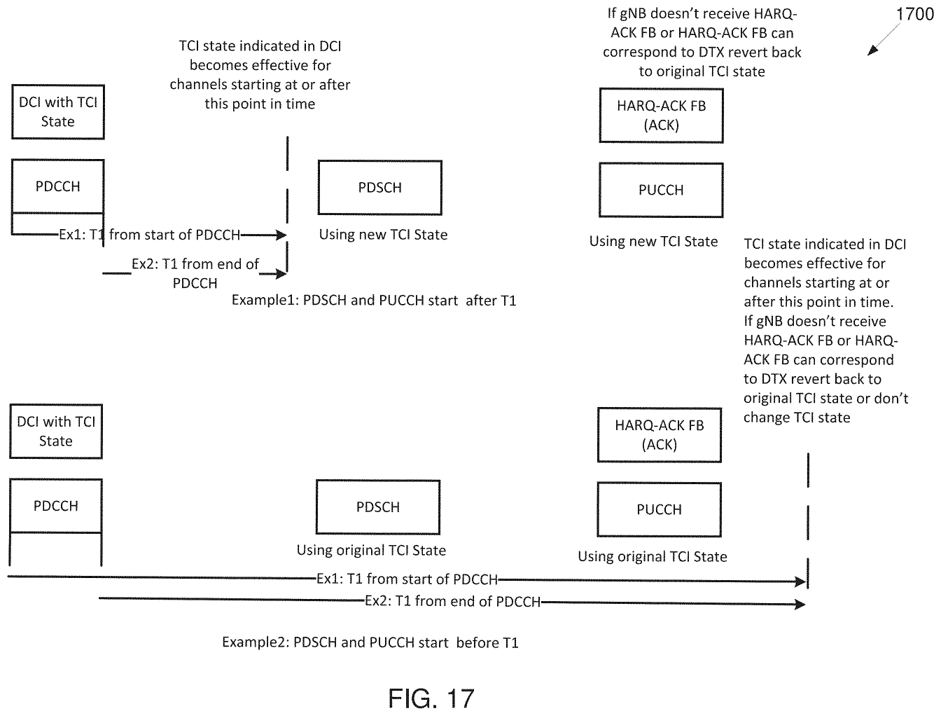

FIG. 17 illustrates an example of a beam the DL-Related DCI 1700 according to embodiments of the present disclosure. An embodiment of the beam the DL-Related DCI 1700 shown in FIG. 17 is for illustration only.

In one example 1.1, the UE can apply the beam after a delay T₁ (e.g., timeDurationForQCL or beam application delay or beam application time) from the DL-Related DCI as shown in FIG. 17.

In one example 1.1.1, as described in U.S. patent application Ser. No. 17/444,556, the time duration T₁ is from the start of the PDCCH carrying the DL-related DCI with TCI state indication (beam indication). In one example, the start of the PDCCH corresponds to the beginning time of the first OFDM symbol that carries the PDCCH.

In another example 1.1.2, the time duration T₁ is from the end of the PDCCH carrying the DL-related DCI with TCI state indication (beam indication) (cf. U.S. patent application Ser. No. 17/444,556). In one example, the end of the PDCCH corresponds to the ending time of the last OFDM symbol that carries the PDCCH.

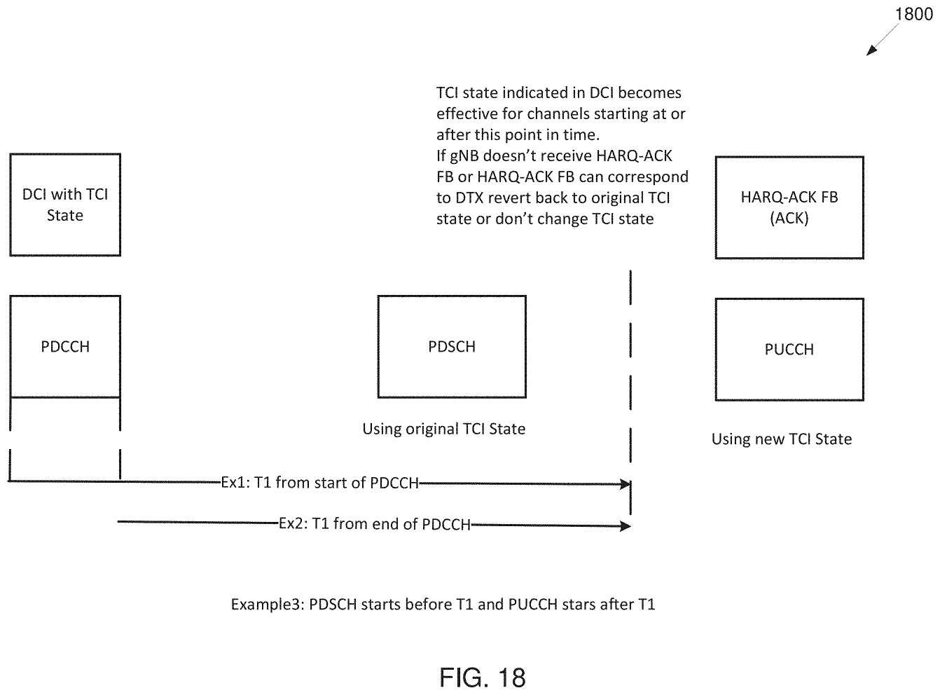

FIG. 18 illustrates another example of a beam the DL-Related DCI 1800 according to embodiments of the present disclosure. An embodiment of the beam the DL-Related DCI 1800 shown in FIG. 18 is for illustration only.

A UE can apply the new beam to the PDSCH associated with the DL-related DCI with TCI state indication and/or PUCCH with HARQ-ACK feedback for the PDSCH associated with the DL-related DCI with TCI state indication when the start time of the corresponding channel is after a time duration T₁ from the PDCCH of the DL-related DCI with TCI state indication.

In FIG. 17 and FIG. 18, there are two examples, in Example 1, the start time of PDSCH and PUCCH associated with DL-related DCI with TCI state indication is after the time duration T₁. In Example 2, the start time of PDSCH and PUCCH associated with DL-related DCI with TCI state indication is before the time duration T₁. In Example 3, the start time of PDSCH associated with DL-related DCI with TCI state indication is before the time duration T₁, however, the start time of PUCCH associated with DL-related DCI with TCI state indication is after the time duration T₁.

If a UE does not acknowledge the PDSCH associated with a DL-related DCI with TCI state indication, the gNB and the UE revert back to the original beam before TCI state update.

In one example 1.1.3, a gNB and a UE (if applicable) revert back to the original beam if the UE does not transmit and gNB does not receive positive HARQ-ACK acknowledgement for the PDSCH transmission associated with the DL-related DCI with TCI state indication.

In another example 1.1.4, a gNB and a UE (if applicable) reverts back to the original beam if the gNB does not receive and the UE does not transmit positive or negative HARQ-ACK acknowledgement for the PDSCH transmission associated with the DL-related DCI with TCI state indication, wherein a negative HARQ-ACK corresponds to a PDSCH with an attempted decode that has not been successful (e.g., with a failed transport block CRC and/or failed codeblock CRC(s)). If the HARQ-ACK codeword received by the gNB and transmitted by the UE can correspond to a DTX, i.e., the PDCCH was not received and accordingly the decoding of PDSCH was not attempted, the gNB and the UE revert back to the original beam.

A codeword corresponding to both NACK and DTX is handled like a codeword that corresponds to DTX as the gNB is uncertain whether the corresponding PDCCH is received and the gNB reverts back to the original TCI state (beam) even though the UE may have received the DCI but failed to decode the PDSCH, the gNB reverts back to the original TCI state (beam) as NACK and DTX are mapped to a same codeword.

In another example 1.1.5, for semi-static HARQ-ACK codebook (i.e., Type-1 HARQ-ACK codebook), or for dynamic HARQ-ACK codebook, (i.e., Type-2 HARQ-ACK codebook), a UE can transmit a PUCCH if at least one DCI is received with the PDSCH-to-HARQ_feedback timing indicator in the DCI pointing to the slot and/or symbols in which PUCCH is transmitted, otherwise there is no PUCCH transmission (i.e., PUCCH DTX).

A transmission of PUCCH and its detection by the gNB is an indication that at least one DCI corresponding to the PUCCH transmission has been received by the UE, and the corresponding TCI state update (e.g., beam change) is confirmed. If a transmission of the PUCCH is not detected at the gNB, it is an indication to the gNB that no corresponding DCI has been received by the UE, and accordingly the gNB reverts back to the original TCI state (e.g., beam).

It can be up to network implementation to ensure that when a TCI state (e.g., beam) is being updated in a DCI corresponding to a PUCCH transmission, that all DCIs pointing (based on the PDSCH-to-HARQ_feedback timing indicator in the corresponding DCI) to the PUCCH transmission include the same updated TCI state, such that if the UE has received any such DCI, the UE may update its TCI state (e.g., beam) accordingly.

In another example 1.1.6, a gNB or a UE can be configured to revert back to the original beam (TCI state): (1) if a UE does not transmit and gNB does not receive positive HARQ-ACK acknowledgement for the PDSCH transmission associated with the DL-related DCI with TCI state indication following example 1.1.3. Positive HARQ-ACK transmission on PUCCH to keep following new beam (TCI state) or (2) if a UE does not transmit and gNB does not receive positive or negative HARQ-ACK acknowledgement for the PDSCH transmission associated with the DL-related DCI with TCI state indication following example 1.1.4 or example 1.1.5. Positive or negative HARQ-ACK transmission on PUCCH to keep following new beam (TCI state). Wherein, the configuration can be by RRC signaling and/or MAC CE signaling.

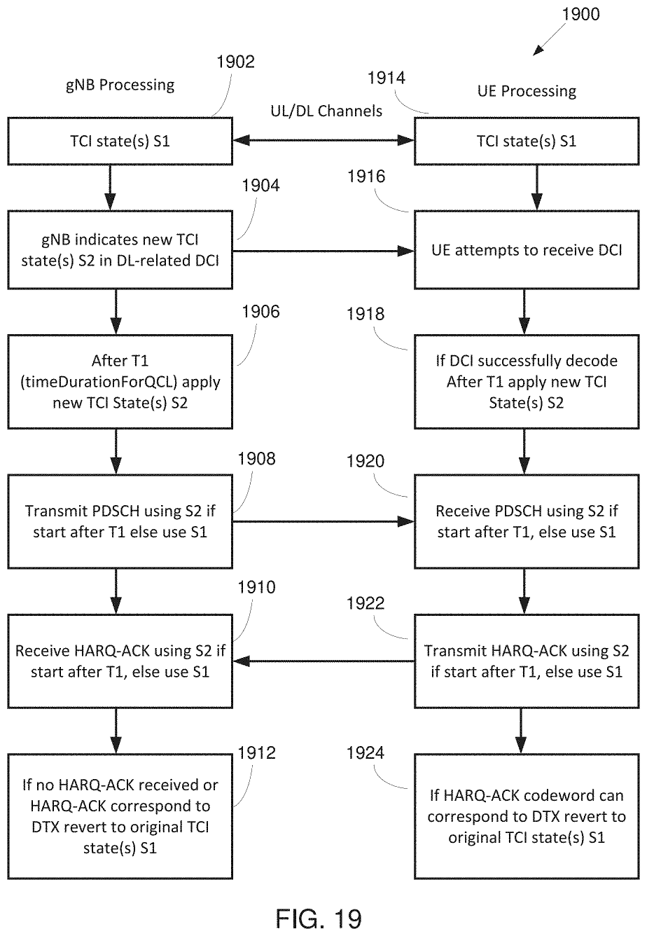

FIG. 19 illustrates an example of a gNB and UE procedure 1900 according to embodiments of the present disclosure. The gNB and UE procedure 1900 1000 as may be performed by a UE (e.g., 111-116 as illustrated in FIG. 1) and a BS (e.g., 101-103 as illustrated in FIG. 1). An embodiment of the gNB and UE procedure 1900 shown in FIG. 19 is for illustration only. One or more of the components illustrated in FIG. 19 can be implemented in specialized circuitry configured to perform the noted functions or one or more of the components can be implemented by one or more processors executing instructions to perform the noted functions.

FIG. 19 illustrates the block diagram of the gNB and the UE processing for example 1.1.4.

As illustrated in FIG. 19, in step 1902, a gNB processes TCI state(s) S1. In step 1904, the gNB indicates new TCI state(s) S2 in DL-related DCI. In step 1906, the gNB applies new TCI state(s) S2 after T1 (timeDurationForQCL). In step 1908, the gNB transmits PDSCH using S2 if starts after T1 else use S1. In step 1910, the gNB receives HARQ-ACK using S2 if starts after T1, else use S1. In step 1912, the gNB, if no HARQ-ACK is received or HARQ-ACK corresponds to DTX, reverts to original TCI state(s) S1. In step 1914, a UE processes the TCI state(s) S1. In step 1916, the UE attempts receive DCI. In step 1918, the UE determines if DCI is successfully decoded after applying T1 to new TCI state(s) S2. In step 1920, the receives PDSCH using S2 if starts after T1, else use S1. In step 1922, the UE transmits HARQ-ACK using S2 if starts after T1, else use S1. In step 1924, the UE determines if HARQ-ACK codeword can correspond to DTX and reverts to original TCI state(s) S1.

In another example 1.1a, a UE is configured two beam application delays for T₁; T₁₁ and T₁₂ the UE can apply the beam after a delay T₁₁ (e.g., timeDurationForQCL or beam application delay or beam application time) from the DL-Related DCI (start or end) as shown in FIG. 17, or after a delay T₁₂ (e.g., timeDurationForQCL or beam application delay or beam application time) from the DL-Related DCI (start or end) as shown in FIG. 17.

In one example 1.1a.1, the UE is configured by a higher layer parameter whether to apply the beam after a delay T₁₁ (e.g., timeDurationForQCL or beam application delay or beam application time) from the DL-Related DCI as shown in FIG. 17, or after a delay T₁₂ (e.g., timeDurationForQCL or beam application delay or beam application time) from the DL-Related DCI (start or end) as shown in FIG. 17.

In one example 1.1a.2, the UE is configured by a MAC CE command whether to apply the beam after a delay T₁₁ (e.g., timeDurationForQCL or beam application delay or beam application time) from the DL-Related DCI as shown in FIG. 17, or after a delay T₁₂ (e.g., timeDurationForQCL or beam application delay or beam application time) from the DL-Related DCI (start or end) as shown in FIG. 17.

In one example 1.1a.3, the UE is configured by DCI command whether to apply the beam after a delay T₁₁ (e.g., timeDurationForQCL) from the DL-Related DCI as shown in FIG. 17, or after a delay T₁₂ (e.g., timeDurationForQCL or beam application delay or beam application time) from the DL-Related DCI (start or end) as shown in FIG. 17.

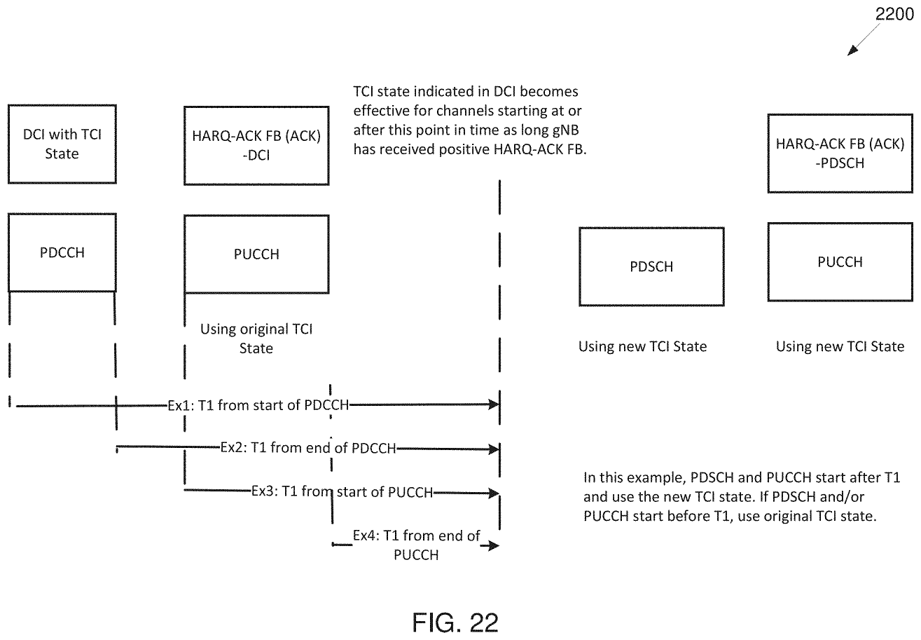

In another example 1.1b, the UE that receives a PDCCH with a DL-related DCI that includes a TCI state(s) can: (1) for a PDSCH associated with the DL-related DCI and a corresponding PUCCH including the corresponding HARQ-ACK feedback, apply the beam (TCI state) indicated in the DL-related DCI: in a further example, a beam delay T₁₁ (e.g., timeDurationForQCL or beam application delay or beam application time) can be specified in the system specifications and/or configured or updated by RRC signaling and/or MAC CE signaling and/or L1 control signaling. If the start of the PDSCH and/or PUCCH associated with the DL-related DCI from the DL-related DCI is less than T₁₁, the UE continues to the use the original beam for the corresponding channel, else if the start of the PDSCH and/or PUCCH associated with the DL-related DCI from the DL-related DCI is more than or equal to T₁₁, the UE switches to the new beam (TCI state) indicated by the DL-related DCI for the corresponding channel; and (2) for DL or UL traffic not associated with the DL-related DCI, the UE applies the beam (i.e., TCI state) after a delay T₁₂ (e.g., timeDurationForQCL or beam application delay or beam application time) from the DL-Related DCI associated with the PDSCH transmission as shown in FIG. 22.

In a further example: (1) a first beam delay T₁₁ (e.g., timeDurationForQCL1 or beam application delay1 or beam application time1) for channels (e.g., PDSCH and corresponding PUCCH) associated with the DL-related DCI can be specified in the system specifications and/or configured or updated by RRC signaling and/or MAC CE signaling and/or L1 control signaling; and (2) a second beam delay T₁₂ (e.g., timeDurationForQCL2 or beam application delay2 or beam application time2) for channels NOT associated with the DL-related DCI can be specified in the system specifications and/or configured or updated by RRC signaling and/or MAC CE signaling and/or L1 control signaling.

In another example, the first beam delay T₁₁ and the second beam delay T₁₂ are determined by the UE based on at least one of the following examples.

In one example, the first beam delay T₁₁ is configured and the second beam delay T₁₂ is determined based on the configured value for T₁₁.

In one example, the second beam delay T₁₂ is configured and the first beam delay T₁₁ is determined based on the configured value for T₁₂.

In one example, the first beam delay T₁₁ and the second beam delay T₁₂ are configured either via a joint parameter or two separate parameters.

In one example, the first beam delay T₁₁ is configured and the second beam delay T₁₂ is fixed.

In one example, the second beam delay T₁₂ is configured and the first beam delay T₁₁ is fixed.

In one example, the first beam delay T₁₁ and the second beam delay T₁₂ are according to one of the above examples, but their values are subject to a UE capability reporting.

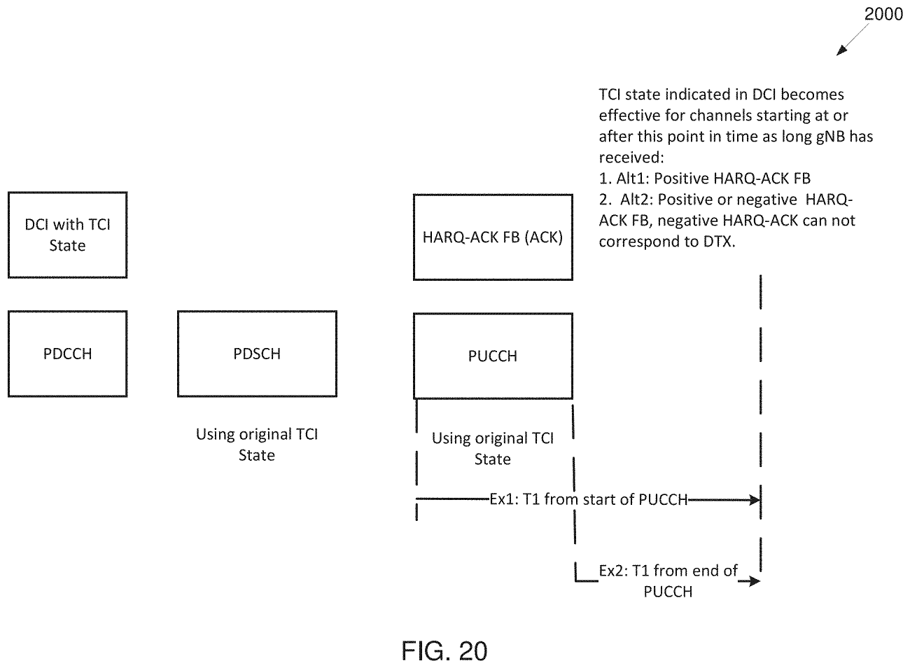

FIG. 20 illustrates an example of a beam based on the HARQ-ACK feedback associated with the PDSCH transmission associated with the DL-Related DCI 2000 according to embodiments of the present disclosure. An embodiment of the beam based on the HARQ-ACK feedback associated with the PDSCH transmission associated with the DL-Related DCI 2000 shown in FIG. 20 is for illustration only.

In another example 1.2, the UE can apply the beam after a delay T₁ (e.g., timeDurationForQCL or beam application delay or beam application time) from the HARQ-ACK feedback associated with the PDSCH transmission associated with the DL-Related DCI as shown in FIG. 20.

In one example 1.2.1, the time duration T₁ is from the start of the PUCCH carrying the corresponding HARQ-ACK feedback (cf. U.S. patent application Ser. No. 17/444,556). In one example, the start of the PUCCH corresponds to the beginning time of the first OFDM symbol that carries the PUCCH.

In another example 1.2.2, the time duration T₁ is from the end of the PUCCH carrying the corresponding HARQ-ACK feedback (cf. U.S. patent application Ser. No. 17/444,556). In one example, the end of the PUCCH corresponds to the ending time of the last OFDM symbol that carries the PUCCH.

A UE uses the original TCI state (beam) for the PDSCH associated with the DL-related DCI with TCI state indication and the PUCCH with HARQ-ACK feedback for the PDSCH associated with the DL-related DCI with TCI state indication.

If a UE does not acknowledge the PDSCH associated with a DL-related DCI with TCI state indication, the gNB and the UE continue to use the original beam before TCI state update.

In one example 1.2.3, a gNB and a UE continue to use the original beam if gNB does not receive and the UE does not transmit positive HARQ-ACK acknowledgement for the PDSCH transmission associated with the DL-related DCI with TCI state indication.

In another example 1.2.4, a gNB and a UE continue to use the original beam if gNB does not receive and the UE does not transmit positive or negative HARQ-ACK acknowledgement for the PDSCH transmission associated with the DL-related DCI with TCI state indication, wherein a negative HARQ-ACK corresponds to a PDSCH with an attempted decode that has not been successful (e.g., with a failed transport block CRC and/or failed codeblock CRC(s)). If the HARQ-ACK codeword received by the gNB and transmitted by the UE corresponds to a DTX, i.e., the PDCCH was not received and accordingly the decoding of PDSCH was not attempted, the gNB and a UE continue to use the original beam.

A codeword corresponding to both NACK and DTX is handled like a codeword that corresponds to DTX as the gNB is uncertain whether the corresponding PDCCH is received and the gNB continues to use the original TCI state (beam), even though the UE may have received the DCI but failed to decode the PDSCH, it continues to use the original TCI state (beam) as NACK and DTX are mapped to a same codeword.

In another example 1.2.5, for semi-static HARQ-ACK codebook (i.e., Type-1 HARQ-ACK codebook), or for dynamic HARQ-ACK codebook, (i.e., Type-2 HARQ-ACK codebook), a UE can transmit a PUCCH if at least one DCI is received with the PDSCH-to-HARQ_feedback timing indicator in the DCI pointing to the slot and/or symbols in which PUCCH is transmitted, otherwise there is no PUCCH transmission (i.e., PUCCH DTX). A transmission of PUCCH and its detection by the gNB is an indication that at least one DCI corresponding to the PUCCH transmission has been received by the UE, and the corresponding TCI state update (e.g., beam change) is confirmed, i.e., the gNB and the UE can use the indicated TCI state after a period T₁ from the PUCCH transmission as illustrated in FIG. 20.

If a transmission of the PUCCH is not detected at the gNB, it is an indication to the gNB that no corresponding DCI has been received by the UE, and accordingly the gNB and the UE continue to use the original TCI state (e.g., beam). It can be up to network implementation to ensure that when a TCI state (e.g., beam) is being updated in a DCI corresponding to a PUCCH transmission, that all DCIs pointing (based on the PDSCH-to-HARQ_feedback timing indicator in the corresponding DCI) to the PUCCH transmission include the same updated TCI state, such that if the UE has received any such DCI, the UE may update its TCI state (e.g., beam) accordingly.

In another example 1.2.6, a gNB or a UE can be configured to continue to use the original beam: (1) if a UE does not transmit and gNB does not receive positive HARQ-ACK acknowledgement for the PDSCH transmission associated with the DL-related DCI with TCI state indication following example 1.1.3. Positive HARQ-ACK transmission on PUCCH to follow new beam (TCI state) or (2) if a UE does not transmit and gNB does not receive positive or negative HARQ-ACK acknowledgement for the PDSCH transmission associated with the DL-related DCI with TCI state indication following example 1.1.4 or example 1.1.5. Positive or negative HARQ-ACK transmission on PUCCH to follow new beam (TCI state). Wherein, the configuration can be by RRC signaling and/or MAC CE signaling.

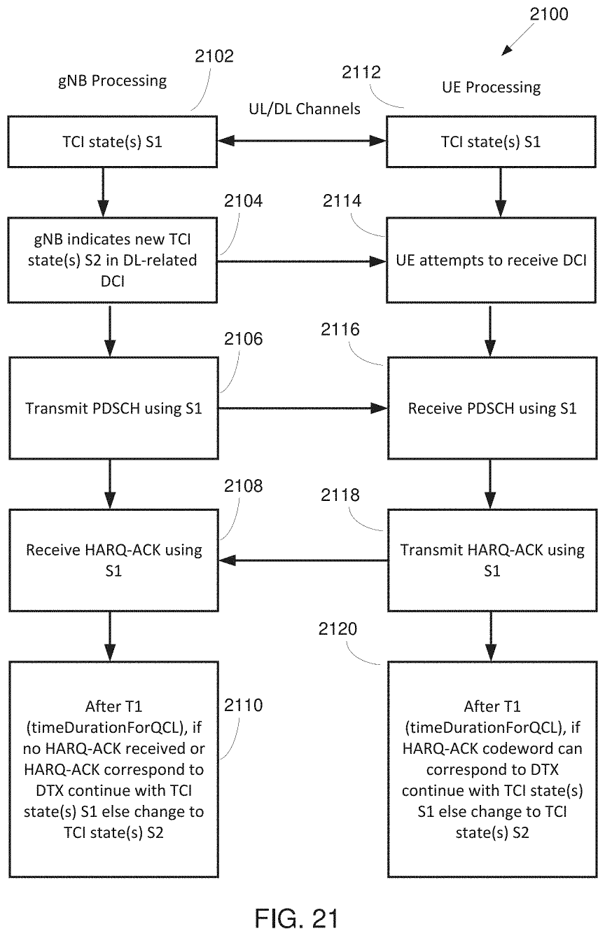

FIG. 21 illustrates an example of a gNB and UE procedure 2100 according to embodiments of the present disclosure. The gNB and UE procedure 2100 1000 as may be performed by a UE (e.g., 111-116 as illustrated in FIG. 1) and a BS (e.g., 101-103 as illustrated in FIG. 1). An embodiment of the gNB and UE procedure 2100 shown in FIG. 21 is for illustration only. One or more of the components illustrated in FIG. 21 can be implemented in specialized circuitry configured to perform the noted functions or one or more of the components can be implemented by one or more processors executing instructions to perform the noted functions.

FIG. 21 illustrates the block diagram of the gNB and UE processing for example 1.2.4.

As illustrates in FIG. 21, in step 2102, a gNB processes TCI state(s) S1. In step 2104, the gNB indicates new TCI state(s) S2 in DL-related DCI. In step 2106, the gNB transmits PDSCH using S1. In step 2108, the gNB receives HARQ-ACK using S1. In step 2110, the gNB, after T1 (timeDurationForQCL), if no HARQ-ACK is received or HARQ-ACK corresponds to DTX continues with TCI state(s) S1, else changes to TCI state(s) S2. In step 2112, a UE processes TCI state(s) S1. In step 2114, the UE attempts to receive DCI. In step 2116, the UE receives PDSCH using S1. In step 2118, the UE transmits HARQ-ACK using S1. In step 2120, the UE, after T1 (timeDurationForQCL), if HARQ-ACK codeword can correspond to DTX, continues with TCI state(s) S1, else changes to TCI state(s) S2.

In another example 1.2a, a UE is configured two beam application delays for T₁; T₁₁ and T₁₂, the UE can apply the beam after a delay T₁₁ (e.g., timeDurationForQCL or beam application delay or beam application time) from the DL-Related DCI (start or end) as shown in FIG. 17, or after a delay T₁₂ (e.g., timeDurationForQCL or beam application delay or beam application time) from the HARQ-ACK feedback (start or end) associated with the PDSCH transmission associated with the DL-Related DCI as shown in FIG. 20. T₁₁ and T₁₂ can be the same or different.

In one example 1.2a.1, the UE is configured by a higher layer parameter whether to apply the beam after a delay T₁₁ (e.g., timeDurationForQCL or beam application delay or beam application time) from the DL-Related DCI as shown in FIG. 17, or after a delay T₁₂ (e.g., timeDurationForQCL or beam application delay or beam application time) from the HARQ-ACK feedback associated with the PDSCH transmission associated with the DL-Related DCI as shown in FIG. 20.

In one example 1.2a.2, the UE is configured by a MAC CE command whether to apply the beam after a delay T₁₁ (e.g., timeDurationForQCL or beam application delay or beam application time) from the DL-Related DCI as shown in FIG. 17, or after a delay T₁₂ (e.g., timeDurationForQCL or beam application delay or beam application time) from the HARQ-ACK feedback associated with the PDSCH transmission associated with the DL-Related DCI as shown in FIG. 20.

In one example 1.2a.3, the UE is configured by a DCI command whether to apply the beam after a delay T₁₁ (e.g., timeDurationForQCL or beam application delay or beam application time) from the DL-Related DCI as shown in FIG. 17, or after a delay T₁₂ (e.g., timeDurationForQCL or beam application delay or beam application time) from the HARQ-ACK feedback associated with the PDSCH transmission associated with the DL-Related DCI as shown in FIG. 20. E.g., based on flag in DCI.

The rest of the sub-examples of example 1.1 and example 1.2 apply according to the configuration of the UE.

In another example 1.2b, the UE that receives a PDCCH with a DL-related DCI that includes a TCI state(s) can: (1) for a PDSCH associated with the DL-related DCI and a corresponding PUCCH including the corresponding HARQ-ACK feedback, apply the beam (TCI state) indicated in the DL-related DCI: in a further example, a beam delay T₁ (e.g., timeDurationForQCL or beam application delay or beam application time) can be specified in the system specifications and/or configured or updated by RRC signaling and/or MAC CE signaling and/or L1 control signaling. If the start of the PDSCH and/or PUCCH associated with the DL-related DCI from the DL-related DCI is less than T₁, the UE continues to the use the original beam for the corresponding channel, else if the start of the PDSCH and/or PUCCH associated with the DL-related DCI from the DL-related DCI is more than or equal to T₁, the UE switches to the new beam (TCI state) indicated by the DL-related DCI for the corresponding channel; and/or (2) for DL or UL traffic not associated with the DL-related DCI, the UE applies the beam (i.e., TCI state) after a delay T₁ (e.g., timeDurationForQCL or beam application delay or beam application time) from the HARQ-ACK feedback associated with the PDSCH transmission associated with the DL-Related DCI as shown in FIG. 20.

In a further example: (1) a first beam delay T₁₁ (e.g., timeDurationForQCL1 or beam application delay1 or beam application time1) for channels (e.g., PDSCH and corresponding PUCCH) associated with the DL-related DCI can be specified in the system specifications and/or configured or updated by RRC signaling and/or MAC CE signaling and/or L1 control signaling; and a second beam delay T₁₂ (e.g., timeDurationForQCL2 or beam application delay2 or beam application time2) for channels NOT associated with the DL-related DCI can be specified in the system specifications and/or configured or updated by RRC signaling and/or MAC CE signaling and/or L1 control signaling.

In another example, the first beam delay T₁₁ and the second beam delay T₁₂ are determined by the UE based on at least one of the following examples.

In one example, the first beam delay T₁₁ is configured and the second beam delay T₁₂ is determined based on the configured value for T₁₁.

In one example, the second beam delay T₁₂ is configured and the first beam delay T₁₁ is determined based on the configured value for T₁₂.

In one example, the first beam delay T₁₁ and the second beam delay T₁₂ are configured either via a joint parameter or two separate parameters.

In one example, the first beam delay T₁₁ is configured and the second beam delay T₁₂ is fixed.

In one example, the second beam delay T₁₂ is configured and the first beam delay T₁₁ is fixed.

In one example, the first beam delay T₁₁ and the second beam delay T₁₂ are according to one of the above examples, but their values are subject to a UE capability reporting.

The rest of the sub-examples of example 1.1 and example 1.2 apply according to the configuration of the UE.

FIG. 22 illustrates an example of a beam based on the HARQ-ACK feedback associated with a DCI transmission with the DL-Related DCI 2200 according to embodiments of the present disclosure. An embodiment of the beam based on the HARQ-ACK feedback associated with a DCI transmission with the DL-Related DCI 2200 shown in FIG. 22 is for illustration only.

In another example 1.3, a DL related DCI with TCI state indication has a HARQ-ACK feedback, separate from the HARQ ACK feedback of corresponding PDSCH. The HARQ-ACK feedback is positive if the DCI is successfully received, if the DCI is not received there is no HARQ-ACK feedback ((DTX in this case) to the gNB/network (as described in component 1). The UE can apply the beam after a delay T₁ (e.g., timeDurationForQCL or beam application delay or beam application time) from the HARQ-ACK feedback associated with a DCI transmission with the DL-Related DCI as shown in FIG. 22.

In one example 1.3.1, the time duration T₁ is from the start of the PDCCH carrying the DL-related DCI with TCI state indication (beam indication) (cf. U.S. application Ser. No. 17/444,556). In one example, the start of the PDCCH corresponds to the beginning time of the first OFDM symbol that carries the PDCCH.

In another example 1.3.2, the time duration T₁ is from the end of the PDCCH carrying the DL-related DCI with TCI state indication (beam indication) (cf. U.S. patent application Ser. No. 17/444,556). In one example, the end of the PDCCH corresponds to the ending time of the last OFDM symbol that carries the PDCCH.

In another example 1.3.3, the time duration T₁ is from the start of the PUCCH carrying the corresponding HARQ-ACK feedback (cf. U.S. patent application Ser. No. 17/444,556). In one example, the start of the PUCCH corresponds to the beginning time of the first OFDM symbol that carries the PUCCH.

In another example 1.3.4, the time duration T₁ is from the end of the PUCCH carrying the corresponding HARQ-ACK feedback (cf. U.S. patent application Ser. No. 17/444,556). In one example, the end of the PUCCH corresponds to the ending time of the last OFDM symbol that carries the PUCCH.

A UE can apply the new beam to the PDSCH associated with the DL-related DCI with TCI state indication and/or PUCCH with HARQ-ACK feedback for the PDSCH associated with the DL-related DCI with TCI state indication when the start time of the corresponding channel is after a time duration T₁ from the PDCCH, or corresponding PUCCH, of the DL-related DCI with TCI state indication. In FIG. 22, the start time of PDSCH and PUCCH associated with DL-related DCI with TCI state indication is after the time duration T₁.

If a UE does not acknowledge the PDCCH with a DL-related DCI with TCI state indication, the gNB and the UE continue to use the original beam before TCI state update.

In one example 1.3.5, a gNB and a UE continue to use the original beam if gNB does not receive and the UE does not transmit positive HARQ-ACK acknowledgement for the PDCCH transmission with the DL-related DCI with TCI state indication.

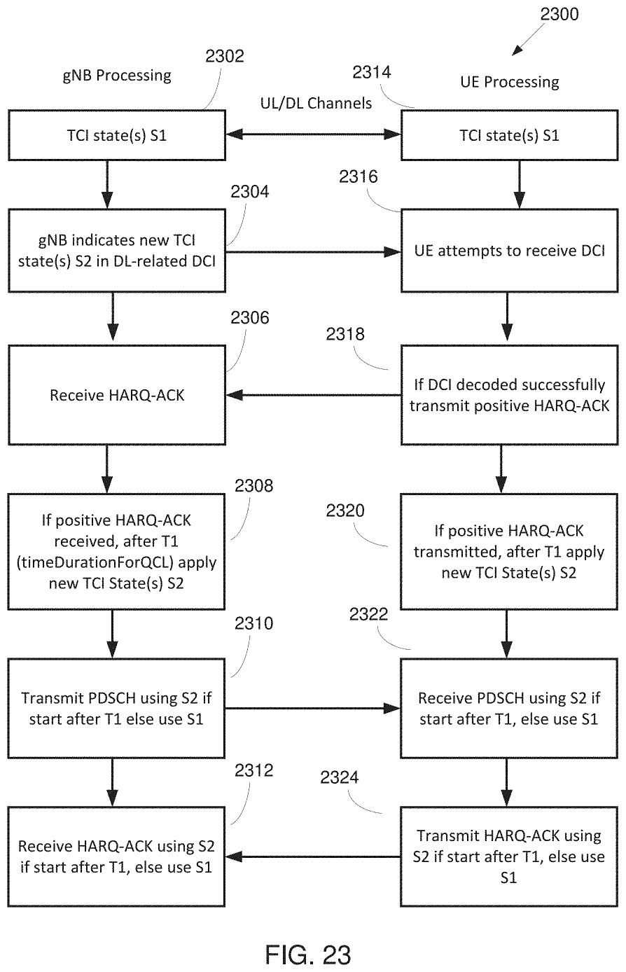

FIG. 23 illustrates an example of a gNB and UE procedure 2300 according to embodiments of the present disclosure. The gNB and UE procedure 2300 as may be performed by a UE (e.g., 111-116 as illustrated in FIG. 1) and a BS (e.g., 101-103 as illustrated in FIG. 1). An embodiment of the gNB and UE procedure 2300 shown in FIG. 23 is for illustration only. One or more of the components illustrated in FIG. 23 can be implemented in specialized circuitry configured to perform the noted functions or one or more of the components can be implemented by one or more processors executing instructions to perform the noted functions.

FIG. 23 illustrates the block diagram of the gNB and UE processing for example 1.3.5.

As illustrated in FIG. 23, in step 2302, a gNB processes TCI state(s) S1. In step 2304, the gNB indicates new TCI state(s) S2 in DL-related DCI. In step 2306, the gNB receives HARQ-ACK. In step 2308, the gNB, if positive HARQ-ACK is received, after T1 (timeDurationForQCL), applies new TCI State(s) S2. In step 2310, the gNB transmits PDSCH the using S2 if starts after T1, else uses S1. In step 2312, the gNB receives HARQ-ACK using S2 if starts after T1, else uses S1. In step 2314, a UE processes TCI state(s) S1. In step 2316, the UE attempts to receive DCI. In step 2318, the UE, if DCI is decoded successfully, transmits positive HARQ-ACK. In step 2320, the UE, if positive HARQ-ACK is transmitted, after T1, applies new TCI State(s) S2. In step 2322, the UE receives PDSCH using S2 if starts after T1, else uses S1. In step 2324, the UE transmits HARQ-ACK using S2 if starts after T1, else uses S1.

In another example 1.3.6, a UE is configured two beam application delays for T₁; T₁₁ and T₁₂, the UE can apply the beam after a delay T₁₁ (e.g., timeDurationForQCL or beam application delay or beam application time) from the DL-Related DCI (start or end) as shown in FIG. 22, or after a delay T₁₂ (e.g., timeDurationForQCL or beam application delay or beam application time) from the HARQ-ACK feedback (start or end) associated with the DL-Related DCI as shown in FIG. 16. T₁₁ and T₁₂ can be the same or different.

In one example 1.3.6.1, the UE is configured by a higher layer parameter whether to apply the beam after a delay T₁₁ (e.g., timeDurationForQCL or beam application delay or beam application time) from the DL-Related DCI as shown in FIG. 22, or after a delay T₁₂ (e.g., timeDurationForQCL or beam application delay or beam application time) from the HARQ-ACK feedback associated with the DL-Related DCI as shown in FIG. 22.

In one example 1.3.6.2, the UE is configured by a MAC CE command whether to apply the beam after a delay T₁₁ (e.g., timeDurationForQCL or beam application delay or beam application time) from the DL-Related DCI as shown in FIG. 22, or after a delay T₁₂ (e.g., timeDurationForQCL or beam application delay or beam application time) from the HARQ-ACK feedback associated with the DL-Related DCI as shown in FIG. 22.

In one example 1.3.6.3, the UE is configured by a DCI command whether to apply the beam after a delay T₁₁ (e.g., timeDurationForQCL or beam application delay or beam application time) from the DL-Related DCI as shown in FIG. 22, or after a delay T₁₂ (e.g., timeDurationForQCL or beam application delay or beam application time) from the HARQ-ACK feedback associated with the DL-Related DCI as shown in FIG. 22.

The rest of the sub-examples of example 1.3 apply according to the configuration of the UE.

In the above examples, the delay T₁ (e.g., timeDurationForQCL or beam application delay or beam application time) can be specified in the system specifications and/or configured or updated by RRC signaling and/or MAC CE signaling and/or L1 control signaling. The delay T₁ (e.g., timeDurationForQCL or beam application delay or beam application time) can further depend on a UE capability.

In one example 1.4, the UE capability defines the earliest switching time from the time of arrival of a PDCCH (start or end) with a DL-related DCI. The network signals through RRC and/or MAC CE and/or L1 control signaling one or more beam switching time(s). Wherein, the beam switching time can be measured from: (1) in one example 1.4.1, the PDCCH (start or end) with the DL-related DCI; and (2) in another example 1.4.2, the HARQ-ACK feedback (start or end) associated with the PDSCH transmission associated with the DL-Related DCI.

The network can ensure that the beam switching time signaled may occur no earlier than the time indicated by the UE capability, otherwise it may be an error case, or it may be up to the implementation of the UE when the beam switching according to the TCI state indicated in the DL related DCI takes effect.

In one example 1.5, a UE is configured a list of cells or component carriers or bandwidth parts for simultaneous TCI state update, the UE receives a DL-related DCI (e.g., DCI format 1_1, DCI format 1_2 or DCI format 1_0) with DL assignment or without DL assignment that includes a TCI state (e.g., TCI state ID or TCI state codepoint from a list of TCI state codepoints activated by a MAC CE command). The UE applies the TCI state, after a beam application delay D as described in example 1.1, 1.2 and 1.3 to the list of cells or component carriers and/or bandwidth parts for simultaneous TCI state update.

In one example 1.5.1, a beam application delay is configured for each (or for some) cell and/or component carrier and/or bandwidth part (BWP) within the list. The UE determines the cell and/or component carrier and/or bandwidth part with the smallest SCS within the list and selects the corresponding beam application delay as the beam application delay D (e.g., time between the HARQ-ACK and the application time of the TCI state).

In one example 1.5.1.1, if more than one cell and/or component carrier and/or bandwidth part has the same smallest SCS, the UE selects the largest beam application delay from the configured values corresponding to the set of cells and/or component carriers and/or bandwidth parts with the smallest SCS as the beam application delay D (e.g., time between the HARQ-ACK and the application time of the TCI state). Let {d₀, d₁, . . . , dₙ₋₁} be the set of configured beam application delays for n cells and/or component carriers and/or bandwidth parts with the smallest SCS, within the list, D=max(d₀, d₁, . . . , dₙ₋₁).

In one example 1.5.1.2, if more than one cell and/or component carrier and/or bandwidth part has the same smallest SCS, the UE selects the smallest beam application delay from the configured values corresponding to the set of cells and/or component carriers and/or bandwidth parts with the smallest SCS as the beam application delay D (e.g., time between the HARQ-ACK and the application time of the TCI state). Let {d₀, d₁, . . . , dₙ₋₁} be the set of configured beam application delays for n cells and/or component carriers and/or bandwidth parts with the smallest SCS, within the list, D=min(d₀, d₁, . . . , dₙ₋₁).

In one example 1.5.1.3, if more than one cell and/or component carrier and/or bandwidth part has the same smallest SCS, the UE expects that the beam application delay for the set of cells and/or component carriers and/or bandwidth parts with the smallest SCS to be configured with a same beam application delay which becomes the beam application delay D (e.g., time between the HARQ-ACK and the application time of the TCI state). Let {d₀, d₁, . . . , dₙ₋₁} be the set of configured beam application delays for n cells and/or component carriers and/or bandwidth parts with the smallest SCS, within the list, the UE expects, d₀=d₁= . . . =dₙ₋₁, which also equals D.

In one example 1.5.1.4, if more than one cell and/or component carrier and/or bandwidth part has the same smallest SCS, the UE is configured an index of the cell and/or component carrier and/or bandwidth part to use its beam application delay configured value for the beam application delay D (e.g., time between the HARQ-ACK and the application time of the TCI state). Let {d₀, d₁, . . . , dₙ₋₁} be the set of configured beam application delays for n cells and/or component carriers and/or bandwidth parts with the smallest SCS, within the list, the UE is configured an index i, D=dᵢ.

In one example 1.5.1.5, if more than one cell and/or component carrier and/or bandwidth part has the same smallest SCS, the UE expects only one such cell and/or component carrier and/or bandwidth part to be configured with a beam application delay which is used as the beam application delay D (e.g., time between the HARQ-ACK and the application time of the TCI state).

In one example 1.5.1.6, a UE expects that all cells and/or component carriers and/or bandwidth parts are configured with the same beam application delay.

In one example 1.5.1.7, a UE expects that all cells and/or component carriers and/or bandwidth parts with same SCS are configured with the same beam application delay.

In one example 1.5.2, a beam application delay is configured for each (or for some) cell and/or component carrier and/or BWP within the list. The UE determines the cell and/or component carrier and/or bandwidth part with the largest SCS within the list and selects the corresponding beam application delay as the beam application delay D (e.g., time between the HARQ-ACK and the application time of the TCI state).

In one example 1.5.2.1, if more than one cell and/or component carrier and/or bandwidth part has the same largest SCS, the UE selects the largest beam application delay from the configured values corresponding to the set of cells and/or component carriers and/or bandwidth parts with the largest SCS as the beam application delay D (e.g., time between the HARQ-ACK and the application time of the TCI state). Let {d₀, d₁, . . . , dₙ₋₁} be the set of configured beam application delays for n cells and/or component carriers and/or bandwidth parts with the largest SCS, within the list, D=max(d₀, d₁, . . . , dₙ₋₁).

In one example 1.5.2.2, if more than one cell and/or component carrier and/or bandwidth part has the same largest SCS, the UE selects the smallest beam application delay from the configured values corresponding to the set of cells and/or component carriers and/or bandwidth parts with the largest SCS as the beam application delay D (e.g., time between the HARQ-ACK and the application time of the TCI state). Let {d₀, d₁, . . . , dₙ₋₁} be the set of configured beam application delays for n cells and/or component carriers and/or bandwidth parts with the largest SCS, within the list, D=min(d₀, d₁, . . . , dₙ₋₁).

In one example 1.5.2.3, if more than one cell and/or component carrier and/or bandwidth part has the same largest SCS, the UE expects that the beam application delay for the set of cells and/or component carriers and/or bandwidth parts with the largest SCS to be configured with a same beam application delay which becomes the beam application delay D (e.g., time between the HARQ-ACK and the application time of the TCI state). Let {d₀, d₁, . . . , dₙ₋₁} be the set of configured beam application delays for n cells and/or component carriers and/or bandwidth parts with the largest SCS, within the list, the UE expects, d₀=d₁= . . . =dₙ₋₁, which also equals D.

In one example 1.5.2.4, if more than one cell and/or component carrier and/or bandwidth part has the same largest SCS, the UE is configured an index of the cell and/or component carrier and/or bandwidth part to use the UE's beam application delay configured value for the beam application delay D (e.g., time between the HARQ-ACK and the application time of the TCI state). Let {d₀, d₁, . . . , dₙ₋₁} be the set of configured beam application delays for n cells and/or component carriers and/or bandwidth parts with the largest SCS, within the list, the UE is configured an index i, D=dᵢ.

In one example 1.5.2.5, if more than one cell and/or component carrier and/or bandwidth part has the same largest SCS, the UE expects only one such cell and/or component carrier and/or bandwidth part to be configured with a beam application delay which is used as the beam application delay D (e.g., time between the HARQ-ACK and the application time of the TCI state).

In one example 1.5.2.6, a UE expects that all cells and/or component carriers and/or bandwidth parts are configured with the same beam application delay.

In one example 1.5.2.7, a UE expects that all cells and/or component carriers and/or bandwidth parts with same SCS are configured with the same beam application delay.

In one example 1.5.3, a beam application delay is configured for each (or for some) cell and/or component carrier and/or BWP within the list. The UE determines the largest beam application delay from the list of cells and/or component carriers and/or bandwidths and uses that value as the beam application delay D (e.g., time between the HARQ-ACK and the application time of the TCI state). Let {d₀, d₁, . . . , dₙ₋₁} be the set of configured beam application delays for n cells and/or component carriers and/or bandwidth parts within the list, D=max(d₀, d₁, . . . , dₙ₋₁).

In one example 1.5.4, a beam application delay is configured for each (or for some) cell and/or component carrier and/or BWP within the list. The UE determines the smallest beam application delay from the list of cells and/or component carriers and/or bandwidths and uses that value as the beam application delay D (e.g., time between the HARQ-ACK and the application time of the TCI state). Let {d₀, d₁, . . . , dₙ₋₁} be the set of configured beam application delays for n cells and/or component carriers and/or bandwidth parts within the list, D=min(d₀, d₁, . . . , dₙ₋₁).

In one example 1.5.5, the configured beam application delay of a cell and/or component carrier and/or bandwidth part is no smaller than a value X that depends on a UE capability and/or a subcarrier spacing of the corresponding cell and/or component carrier and/or bandwidth part.

In one example 1.5.6, the list of cells and/or component carriers and/or BWPs for simultaneous TCI state update includes no more than one BWP (e.g., active BWP) per component carrier.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive configuration information for a list of transmission configuration indication (TCI) states,
receive TCI state code points activated via a medium access control-control element (MAC CE), and
receive a downlink control information (DCI) format indicating at least one of the activated TCI state code points, wherein:
the DCI format is DCI format 1_1 or DCI format 1_2,
the DCI format does not include a downlink (DL) assignment, and
the DCI format includes fields set to a bit pattern; and
a processor operably coupled to the transceiver, the processor configured to:
determine whether the DCI format is successfully received,
determine a TCI state to apply based on the at least one indicated TCI state code point, and
update, based on the determined TCI state, (i) quasi-co-location (QCL) assumption for DL channels and signals or (ii) spatial filters for uplink (UL) channels and signals,
wherein the transceiver is further configured to:
transmit hybrid automatic repeat request acknowledgement (HARQ-ACK) feedback as a positive acknowledgment (ACK) in response to a determination that the DCI format is successfully received, and
at least one of (i) receive the DL channels and signals based on the updated QCL assumption and (ii) transmit the UL channels and signals based on the updated spatial filters.

2. The UE claim 1, wherein the TCI state code points are one of:
a joint TCI state,
a DL TCI state,
an UL TCI state, or
a pair of TCI states including DL and UL TCI states.

3. The UE of claim 1, wherein a cyclic redundancy check (CRC) of the DCI format is scrambled with a configured scheduling—radio network temporary identifier (CS-RNTI).

4. The UE of claim 1, wherein the bit pattern includes:
a redundancy version (RV) field set to all ‘1’s,
a modulation and coding scheme (MCS) field set to all ‘1’s,
a new data indicator (NDI) field set to ‘0’; and
a frequency domain resource allocation field (FDRA) field set as follows:
for FDRA type ‘0’ set to all ‘0’s,
for FDRA type ‘1’ set to all ‘1’s, and
for FDRA dynamicSwitch set all ‘0’s.

5. The UE of claim 1, wherein:
a location of the ACK within a Type-1 HARQ-ACK codebook is determined based on a virtual physical downlink shared channel (PDSCH), and
the virtual PDSCH is based on time domain resource assignment (TDRA) field of the DCI format and a time domain allocation list configured for PDSCH.

6. The UE of claim 1, wherein a location of the ACK within a Type-2 HARQ-ACK codebook is determined following the same rules as that of a semi-persistent scheduling (SPS) physical DL shared channel (PDSCH) release.

7. The UE of claim 1, wherein:
the ACK is reported k physical UL control channel (PUCCH) slots after an end of a physical DL control channel (PDCCH) carrying the DCI format, and
k is provided by a physical DL shared channel (PDSCH)-to-HARQ feedback timing indicator field in the DCI format.

8. A base station (BS), comprising:
a transceiver configured to:
transmit configuration information for a list of transmission configuration indication (TCI) states, and
transmit TCI state code points activated via a medium access control-control element (MAC CE), and
a processor operably coupled to the transceiver, the processor configured to determine at least one TCI state code point from the activated TCI state code points for indication to a user equipment (UE),
wherein the transceiver is further configured to:
transmit a downlink control information (DCI) format indicating the at least one determined TCI state code point, wherein:
the DCI format is DCI format 1_1 or DCI format 1_2,
the DCI format does not include a downlink (DL) assignment, and
the DCI format includes fields set to a bit pattern; and
receive hybrid automatic repeat request acknowledgement (HARQ-ACK) feedback,
wherein the processor is further configured to, if a positive acknowledgment (ACK) is received in the HARQ-ACK feedback, update, based on the at least one determined TCI state code point, (i) quasi-co-location (QCL) assumption for DL channels and signals or (ii) spatial filters for uplink (UL) channels and signals, and
wherein the transceiver is further configured to at least one of (i) transmit the DL channels and signals based on the updated QCL assumption and (ii) receive the UL channels and signals based on the updated spatial filters.

9. The BS claim 8, wherein the TCI state code points are one of:
a joint TCI state,
a DL TCI state,
an UL TCI state, or
a pair of TCI states including DL and UL TCI states.

10. The BS of claim 8, wherein a cyclic redundancy check (CRC) of the DCI format is scrambled with a configured scheduling—radio network temporary identifier (CS-RNTI).

11. The BS of claim 8, wherein the bit pattern includes,
a redundancy version (RV) field to set all ‘1’s,
a modulation and coding scheme (MCS) field set to all ‘1’s,
a new data indicator (NDI) field set to ‘0’; and
a frequency domain resource allocation field (FDRA) field set as follows:
for FDRA type ‘0’ set to all ‘0’s,
for FDRA type ‘1’ set to all ‘1’s, and
for FDRA dynamicSwitch set all ‘0’s.

12. The BS of claim 8, wherein
a location of the ACK within a Type-1 HARQ-ACK codebook is determined based on a virtual physical downlink shared channel (PDSCH), and
the virtual PDSCH is based on time domain resource assignment (TDRA) field of the DCI format and a time domain allocation list configured for PDSCH.

13. The BS of claim 8, wherein a location of the ACK within a Type-2 HARQ-ACK codebook is determined following the same rules as that of a semi-persistent scheduling (SPS) physical DL shared channel (PDSCH) release.

14. The BS of claim 8, wherein:
the ACK is reported k physical UL control channel (PUCCH) slots after an end of a physical DL control channel (PDCCH) carrying the DCI format, and
k is provided by a physical DL shared channel (PDSCH)-to-HARQ feedback timing indicator field in the DCI format.

15. A method of operating a user equipment (UE), the method comprising:
receiving configuration information for a list of transmission configuration indication (TCI) states;
receiving TCI state code points activated via a medium access control-control element (MAC CE);
receiving a downlink control information (DCI) format indicating at least one of the activated TCI state code points, wherein:
the DCI format is DCI format 1_1 or DCI format 1_2,
the DCI format does not include a downlink (DL) assignment, and
the DCI format includes fields set to a bit pattern;
determining whether the DCI format is successfully received;
determining a TCI state to apply based on the at least one indicated TCI state code point;
updating, based on the determined TCI state, (i) quasi-co-location (QCL) assumption for DL channels and signals or (ii) spatial filters for uplink (UL) channels and signals;
transmitting hybrid automatic repeat request acknowledgement (HARQ-ACK) feedback as a positive acknowledgment (ACK) in response to determining that the DCI format is successfully received; and
at least one of (i) receiving the DL channels and signals based on the updated QCL assumption and (ii) transmitting the UL channels and signals based on the updated spatial filters.

16. The method of claim 15, wherein a cyclic redundancy check (CRC) of the DCI format is scrambled with a configured scheduling—radio network temporary identifier (CS-RNTI).

17. The method of claim 15, wherein the bit pattern includes:
a redundancy version (RV) field set to all ‘1’s,
a modulation and coding scheme (MCS) field set to all ‘1’s,
a new data indicator (NDI) field set to ‘0’; and
a frequency domain resource allocation field (FDRA) field set as follows:
for FDRA type ‘0’ set to all ‘0’s,
for FDRA type ‘1’ set to all ‘1’s, and
for FDRA dynamicSwitch set all ‘0’s.

18. The method of claim 15, wherein:
a location of the ACK within a Type-1 HARQ-ACK codebook is determined based on a virtual physical downlink shared channel (PDSCH), and
the virtual PDSCH is based on time domain resource assignment (TDRA) field of the DCI format, and a time domain allocation list configured for PDSCH.

19. The method of claim 15, wherein a location of the ACK within a Type-2 HARQ-ACK codebook is determined following the same rules as that of a semi-persistent scheduling (SPS) physical DL shared channel (PDSCH) release.

20. The method of claim 15, wherein
the ACK is reported k physical UL control channel (PUCCH) slots after an end of a physical DL control channel (PDCCH) carrying the DCI format, and
k is provided by a physical DL shared channel (PDSCH)-to-HARQ feedback timing indicator field in the DCI format.
